(19) United States
(12) Patent Application Publication
(10) Pub. No.: US 2025/0323758 A1
(43) Pub. Date: Oct. 16, 2025

(54) UNSUCCESSFUL TERMINATION OF A HYBRID AUTOMATIC REPEAT REQUEST PROCESS ASSOCIATED WITH A SEMI-PERSISTENT SCHEDULING TRANSMISSION

(71) Applicant: QUALCOMM Incorporated, San Diego, CA (US)

(72) Inventors: Mostafa KHOSHNEVISAN, San Diego, CA (US); Jing SUN, San Diego, CA (US)

(21) Appl. No.: 18/634,823

(22) Filed: Apr. 12, 2024

(51) Int. Cl. H04L 1/1812; H04W 72/11; H04W 72/1273

(52) U.S. Cl. CPC H04L 1/1812; H04W 72/11; H04W 72/1273

(57) ABSTRACT

Various aspects of the present disclosure generally relate to wireless communication. Some aspects more specifically relate to a user equipment (UE) identifying and reporting unsuccessful hybrid automatic repeat request (HARQ) process terminations in instances of semi-persistent scheduling (SPS) transmissions. For example, the UE may identify an unsuccessful termination of a HARQ process in instances where the UE receives control information scheduling a transmission or receives an SPS having a same HARQ identifier associated with a previously-received transport block that the UE has not successfully decoded. Additionally or alternatively, the UE may identify an unsuccessful termination of a HARQ process in response to a new data indicator (NDI) associated with a non-SPS transmission being different from an expected value of the NDI.

### FIELD OF THE DISCLOSURE

Aspects of the present disclosure generally relate to wireless communication and specifically relate to techniques, apparatuses, and methods associated with an unsuccessful termination of a hybrid automatic repeat request process associated with a semi-persistent scheduling transmission.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

In some wireless communication networks, devices (for example, a user equipment (UE) and a network node) may perform a hybrid automatic repeat request (HARQ) process to improve a reliability of communications exchanged between the devices. For example, a transmitting device may send a transport block (for example, data) to a receiving device, and the receiving device may attempt to decode the data. In cases where the receiving device successfully decodes the data, the receiving device may transmit a HARQ acknowledgement (ACK) message to the transmitting device. Additionally, in cases where the receiving device fails to successful decode the data, the receiving device may transmit a HARQ negative ACK (NACK) message to the transmitting device. In some cases, a transmitting device may incorrectly detect an ACK message in instances where the receiving device indicated a NACK message. Such errors may decrease a reliability of communications between the transmitting and receiving devices, may introduce latency into communications between the transmitting and receiving devices, or may otherwise degrade a quality of the communications between the transmitting and receiving devices.

### SUMMARY

Some aspects described herein relate to a method of wireless communication by a user equipment (UE). The method may include receiving, from a network node, first signaling associated with a first transport block, the first signaling indicating that the first transport block has a same hybrid automatic repeat request (HARQ) identifier as a second transport block, wherein at least one of the first transport block and the second transport block are associated with semi-persistent scheduling (SPS). The method may include identifying an unsuccessful termination of a HARQ process associated with the second transport block in response to a failure of the UE to successfully decode the second transport block, the first transport block having the same HARQ identifier as the second transport block, or a new data indicator associated with the same HARQ identifier. The method may include transmitting, to the network node, second signaling indicating the unsuccessful termination of the HARQ process associated with the second transport block.

Some aspects described herein relate to a method of wireless communication by a network node. The method may include transmitting, to a UE, first signaling associated with a first transport block, the first signaling indicating that the first transport block has a same HARQ identifier as a second transport block, wherein at least one of the first transport block and the second transport block are associated with SPS. The method may include receiving, from the UE, second signaling indicating an unsuccessful termination of a HARQ process associated with the second transport block in response to a failure of the UE to successfully decode the second transport block, the first transport block having the same HARQ identifier as the second transport block, or a new data indicator associated with the same HARQ identifier.

Some aspects described herein relate to a UE for wireless communication. The UE may include a processing system that includes one or more processors and one or more memories coupled with the one or more processors. The processing system may be configured to cause the UE to receive, from a network node, first signaling associated with a first transport block, the first signaling indicating that the first transport block has a same HARQ identifier as a second transport block, wherein at least one of the first transport block and the second transport block are associated with SPS. The processing system may be configured to cause the UE to identify an unsuccessful termination of a HARQ process associated with the second transport block in response to a failure of the UE to successfully decode the second transport block, the first transport block having the same HARQ identifier as the second transport block, or a new data indicator associated with the same HARQ identifier. The processing system may be configured to cause the UE to transmit, to the network node, second signaling indicating the unsuccessful termination of the HARQ process associated with the second transport block.

Some aspects described herein relate to a network node for wireless communication. The network node may include a processing system that includes one or more processors and one or more memories coupled with the one or more processors. The processing system may be configured to cause the network node to transmit, to a UE, first signaling associated with a first transport block, the first signaling indicating that the first transport block has a same HARQ identifier as a second transport block, wherein at least one of the first transport block and the second transport block are associated with SPS. The processing system may be configured to cause the network node to receive, from the UE, second signaling indicating an unsuccessful termination of a HARQ process associated with the second transport block in response to a failure of the UE to successfully decode the second transport block, the first transport block having the same HARQ identifier as the second transport block, or a new data indicator associated with the same HARQ identifier.

Some aspects described herein relate to a non-transitory computer-readable medium that stores a set of instructions for wireless communication by a UE. The set of instructions, when executed by one or more processors of the UE, may cause the UE to receive, from a network node, first signaling associated with a first transport block, the first signaling indicating that the first transport block has a same HARQ identifier as a second transport block, wherein at least one of the first transport block and the second transport block are associated with SPS. The set of instructions, when executed by one or more processors of the UE, may cause the UE to identify an unsuccessful termination of a HARQ process associated with the second transport block in response to a failure of the UE to successfully decode the second transport block, the first transport block having the same HARQ identifier as the second transport block, or a new data indicator associated with the same HARQ identifier. The set of instructions, when executed by one or more processors of the UE, may cause the UE to transmit, to the network node, second signaling indicating the unsuccessful termination of the HARQ process associated with the second transport block.

Some aspects described herein relate to a non-transitory computer-readable medium that stores a set of instructions for wireless communication by a network node. The set of instructions, when executed by one or more processors of the network node, may cause the network node to transmit, to a UE, first signaling associated with a first transport block, the first signaling indicating that the first transport block has a same HARQ identifier as a second transport block, wherein at least one of the first transport block and the second transport block are associated with SPS. The set of instructions, when executed by one or more processors of the network node, may cause the network node to receive, from the UE, second signaling indicating an unsuccessful termination of a HARQ process associated with the second transport block in response to a failure of the UE to successfully decode the second transport block, the first transport block having the same HARQ identifier as the second transport block, or a new data indicator associated with the same HARQ identifier.

Some aspects described herein relate to an apparatus for wireless communication. The apparatus may include means for receiving, from a network node, first signaling associated with a first transport block, the first signaling indicating that the first transport block has a same HARQ identifier as a second transport block, wherein at least one of the first transport block and the second transport block are associated with SPS. The apparatus may include means for identifying an unsuccessful termination of a HARQ process associated with the second transport block in response to a failure of the UE to successfully decode the second transport block, the first transport block having the same HARQ identifier as the second transport block, or a new data indicator associated with the same HARQ identifier. The apparatus may include means for transmitting, to the network node, second signaling indicating the unsuccessful termination of the HARQ process associated with the second transport block.

Some aspects described herein relate to an apparatus for wireless communication. The apparatus may include means for transmitting, to a UE, first signaling associated with a first transport block, the first signaling indicating that the first transport block has a same HARQ identifier as a second transport block, wherein at least one of the first transport block and the second transport block are associated with SPS. The apparatus may include means for receiving, from the UE, second signaling indicating an unsuccessful termination of a HARQ process associated with the second transport block in response to a failure of the UE to successfully decode the second transport block, the first transport block having the same HARQ identifier as the second transport block, or a new data indicator associated with the same HARQ identifier.

Aspects of the present disclosure may generally be implemented by or as a method, apparatus, system, computer program product, non-transitory computer-readable medium, UE, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example associated with identifying unsuccessful terminations of hybrid automatic repeat request (HARQ) processes, in accordance with the present disclosure.

FIGS. 5 through 10 are diagrams illustrating examples of signaling exchanged between a transmitting and receiving device in accordance with the present disclosure.

FIG. 11 is a diagram illustrating an example of signaling exchanged between a network node and a UE, in accordance with the present disclosure.

FIGS. 12 and 13 are flowcharts illustrating example processes that support wireless communication in accordance with the present disclosure.

FIGS. 14 and 15 are diagrams of example apparatuses for wireless communication in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, devices (for example, a user equipment (UE) and a network node) may perform a hybrid automatic repeat request (HARQ) process to improve a reliability of communications exchanged between the devices. For example, a transmitting device may send a transport block (for example, data) to a receiving device, and the receiving device may attempt to decode the data. In cases where the receiving device successfully decodes the data, the receiving device may transmit a HARQ acknowledgement (ACK) message to the transmitting device. Additionally, in cases where the receiving device fails to successful decode the data, the receiving device may transmit a HARQ negative ACK (NACK) message to the transmitting device. In response to receiving a HARQ NACK message from the receiving device, the transmitting device may perform a retransmission associated with the transport block. For example, the transmitting device may retransmit a portion of the transport block (for example, corresponding to the portion of the transport block that the receiving device was unable to successfully decode). Additionally or alternatively, the transmitting device may retransmit the transport block using a same or different redundancy version (for example, using the same or different set of coded bits associated with the transport block), which may allow for the receiving device to perform soft combining or incremental redundancy combining. Upon receiving the retransmission from the transmitting device, the receiving device may attempt to decode the transport block using a combination of the data received in the initial transmission of the transport block and the data received in the retransmission.

In some cases, the transmitting device may continue to send retransmissions associated with the transport block until the transmitting device receives a HARQ ACK message from the receiving device (for example, indicating that the receiving device successfully decoded the transport block). In response to receiving the HARQ ACK message from the receiving device, the transmitting device may terminate the HARQ process. To terminate the HARQ process, the transmitting device may discard data associated with the transport block (for example, from a buffer that is maintained prior to the termination of the HARQ process). In some other cases, the transmitting device may terminate the HARQ process without receiving a HARQ ACK message from the receiving device. For example, the transmitting device may terminate the HARQ process after a quantity of retransmissions performed by the transmitting device satisfies (for example, is equal to or greater than) a quantity threshold associated with a quantity of retransmissions.

In some wireless communication networks, the devices may additionally support certain radio link control (RLC) processes to improve a reliability of communications between devices. The RLC processes may correspond to processes and communications performed at an RLC layer of the devices. In some cases, the receiving device may detect “holes” (for example, may detect one or more RLC service data unit (SDU) segments that the receiving device has failed to decode) as part of an RLC automatic repeat request (ARQ) process. For example, the receiving device may detect holes based on or otherwise associated with a sequence number associated with the RLC SDU segments, segmentation information associated with the RLC SDU segments, and/or a segment offset associated with the RLC SDU segments.

The receiving device may indicate the detected holes to the transmitting device via an RLC status report. For example, the receiving device may transmit the RLC status report to the transmitting device, and the RLC status report may include ARQ ACKs and/or ARQ NACKs associated with the RLC SDUs and/or RLC SDU segments. In cases where the RLC status report indicates an ARQ NACK for one or more RLC SDUs or RLC SDU segments, the transmitting device may retransmit the RLC SDUs and/or RLC SDU segments indicated as not successfully decoded by the ARQ NACKS in the RLC status report.

The receiving device may transmit an RLC NACK or RLC ACK responsive to, based on, or otherwise associated with detecting or failing to detect holes associated with the RLC ARC processes, respectively. In some cases, the receiving device transmitting an RLC NACK may trigger the transmitting device to retransmit one or more segments of the RLC SDU. Additionally, the receiving device transmitting an RLC ACK may trigger the transmitting device to release a buffer (for example, an upper layer buffer) associated with the RLC SDU.

A receiving device may detect holes as part of an RLC process when the RLC is operating in accordance with the acknowledgement mode in instances where the transmitting device terminates the HARQ process without receiving a HARQ ACK from the receiving device (for example, due to a channel condition between the transmitting and receiving devices, due to a quantity of retransmissions of the transport block performed as part of the HARQ process satisfying a threshold). In another example, the receiving device may detect holes as part of an RLC process when the RLC layer is operating in accordance with the acknowledgement mode as a result of a premature ARQ process initiation. Here, the receiving device may transmit an RLC NACK to the transmitting device in cases where the HARQ process has not been terminated (for example, in an RLC status report), and may eventually decode the transport block via the HARQ process. Additionally, the receiving device may detect holes as part of the RLC process in instances of a NACK to ACK error. For example, if the receiving device transmits a HARQ NACK to the transmitting device (or indicates a HARQ NACK by refraining from transmitting a HARQ ACK) and the transmitting device interprets the HARQ NACK as a HARQ ACK, the transmitting device May terminate the HARQ process (for example, may stop transmissions and/or retransmissions for a transport block).

In some cases, a receiving device (for example, a UE) may detect NACK to ACK errors based on or otherwise associated with hole detection and a timer. That is, the UE may be configured to transmit an RLC status report indicating RLC NACKs upon an expiration of the timer. The expiration time of the timer may be configured with a value to decrease a latency associated with the UE detecting and reporting NACK to ACK errors while also avoiding instances that the UE initiates a premature ARQ process (for example, when the UE transmits an RLC NACK associated with a transport block and subsequently decodes the transport block as part of a HARQ process). In some cases, increasing an amount of time prior to the expiration of the timer may decrease a likelihood that the UE initiates the premature ARQ process, but may in turn increase a latency associated with the UE detecting the NACK to ACK errors.

In some wireless communication networks, a receiving device (for example, a UE) may detect NACK to ACK errors prior to an expiration of the timer associated with the UE indicating RLC NACKs. That is, the UE may detect an unsuccessful termination of a HARQ process (for example, due to a NACK to ACK error) associated with a transport block prior to the expiration of the timer, and may report the unsuccessful termination of the HARQ process associated with the transport block to a transmitting device (for example, a network node). For example, the UE may detect and report instances that a transport block associated with a HARQ process identifier is not decoded and the UE receives another transport block associated with the same HARQ process identifier. Additionally, the UE may detect and report instances that a transport block associated with a HARQ identifier is associated with a new data indicator (NDI) value that is different from an expected value (for example, which may correspond to instances that the UE previously failed to receive or decode control information scheduling another transport block associated with the same HARQ identifier and the other transport block).

In some examples, one or both transport blocks (for example, of an initial transport block that is not successfully decoded by the UE and the other transport block, having the same HARQ identifier as the initial transport block, that is scheduled for transmission while the UE has not successfully decoded the initial transport block) may correspond to a semi-persistent scheduling (SPS) transmission. Here, the NDI value associated with the SPS transmission may be configured differently than NDI values associated with non-SPS transmissions (for example, transmissions that are associated with dynamic grants). In particular, because SPS transmissions are not dynamically scheduled by control information (for example, by downlink control information (DCI)), NDIs for SPS transmissions may not be related to a previously or subsequently transmitted transport block having a same HARQ identifier. Accordingly, the UE may be unable to detect unsuccessful terminations of HARQ processes associated with one or more SPS transmissions based on or otherwise associated with the values of the NDI indicating that one or more previously transmitted transport blocks have not been received and/or decoded by the UE. As a result, the UE may fail to identify and report NACK to ACK errors in instances of SPS transmissions.

Various aspects relate generally to a UE identifying and reporting unsuccessful HARQ process terminations in instances of SPS transmissions (for example, prior to an expiration of the timer associated with the UE indicating RLC NACKs). Some aspects more specifically relate to the UE identifying an unsuccessful termination of a HARQ process in instances where the UE receives control information scheduling a transmission or receives an SPS having a same HARQ identifier associated with a previously-received transport block that the UE has not successfully decoded. Additionally or alternatively, the network node may configure the value of NDIs associated with non-SPS transmissions to be based on or otherwise associated with SPS transmissions associated with the same HARQ identifier as the non-SPS transmission. In some examples, the network node may configure the NDIs associated with a same HARQ identifier to be incremented by one in response to SPS transmissions (such as initial SPS transmissions) and in response to non-SPS transmissions (such as in response to dynamic grant physical downlink shared channel (DG-PDSCH) transmissions). In some other examples, the network node may configure the NDIs associated with a same HARQ identifier to be incremented by one in response to non-SPS transmissions, but not in response to any SPS transmissions. In some other examples, the network node may configure the NDIs associated with a same HARQ identifier to be a certain value (such as a predetermined or fixed value) for non-SPS transmissions scheduled after SPS transmissions associated with the same HARQ identifier. The non-SPS transmissions may correspond to PDSCHs associated with a cell radio network temporary identifier (C-RNTI) (or, in some other cases, a modulation and coding scheme C-RNTI (MCS-C-RNTI) that are scheduled by a corresponding DCI. The SPS transmissions may correspond to PDSCHs associated with a configured scheduling radio network temporary identifier (CS-RNTI), and may include an initial SPS transmission (which may not have a corresponding DCI) or a retransmission of the SPS transmission (which may be scheduled by a DCI with a cyclic redundancy check (CRC) scrambled by the CS-RNTI).

In these examples, the UE may identify an unsuccessful termination of a HARQ process in response to an NDI associated with a non-SPS transmission being different from an expected value of the NDI. The UE may then report the unsuccessful termination of the HARQ process and the network node may initiate an ARQ process (for example, responsive to, based on, or otherwise associated with receiving the report from the UE that indicates the unsuccessful termination of the HARQ process) prior to the expiration of the timer.

Particular aspects of the subject matter described in this disclosure can be implemented to realize one or more of the following potential advantages. In some examples, the described techniques can be used to decrease a latency and signaling overhead associated with communications between devices. For example, the described techniques may enable the UE to identify HARQ process terminations prior to the expiration of the timer even in instances where one or more transport blocks associated with the same HARQ process identifier are associated with SPS transmissions. The UE identifying the HARQ process terminations prior to the expiration of the timer may decrease the latency associated with initiating RLC retransmissions in instances SPS transmissions without increasing signaling overhead (for example, due to increased instances of the UE initiating the ARQ process prematurely). Additionally, the described techniques can be used to decrease overhead at the UE by decreasing buffering at the UE (or at another receiving device). For example, if a latency associated with receiving missing packets (for example, missing RLC SDUs, missing RCL SDU segments) is reduced by decreasing a delay associated with initiating ARQ processes, the UE can decrease a usage of a high-layer buffer (for example, a buffer at the RLC layer, a buffer at the PDCP layer) in cases when in-order delivery of packets is required (for example, such as when the RLC is operating in accordance with the acknowledgement mode).

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

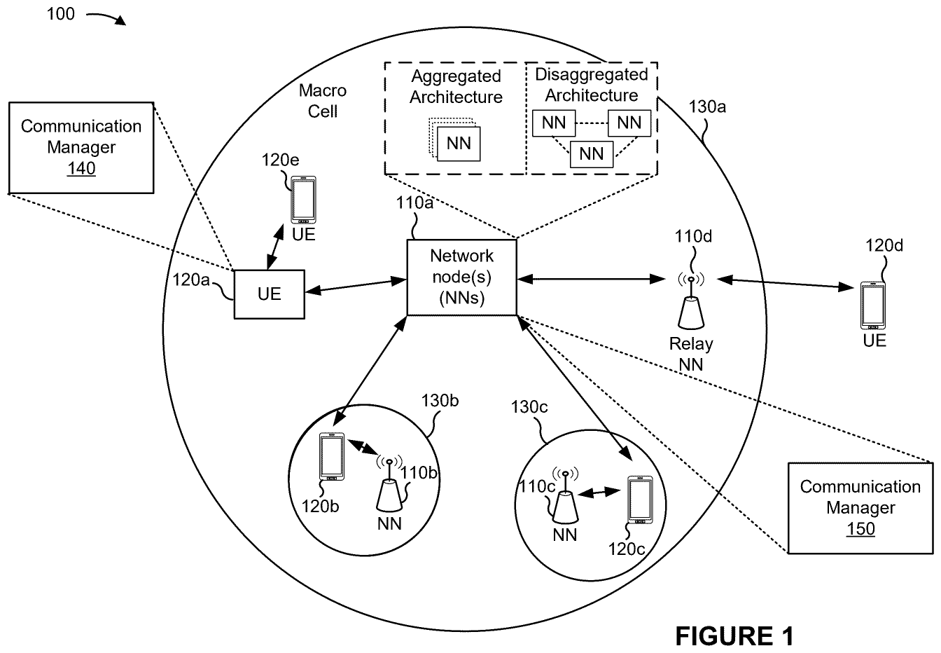

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHZ, FR1 is often referred to (interchangeably) as a “Sub-6 GHZ” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node May have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of an RLC layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 May support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c.Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit DCI (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive, from a network node, first signaling associated with a first transport block, the first signaling indicating that the first transport block has a same HARQ identifier as a second transport block, wherein at least one of the first transport block and the second transport block are associated with SPS; identify an unsuccessful termination of a HARQ process associated with the second transport block in response to a failure of the UE to successfully decode the second transport block, the first transport block having the same HARQ identifier as the second transport block, or an NDI associated with the same HARQ identifier; and transmit, to the network node, second signaling indicating the unsuccessful termination of the HARQ process associated with the second transport block. Additionally or alternatively, the communication manager 140 may perform one or more other operations described herein.

In some aspects, the network node 110 may include a communication manager 150. As described in more detail elsewhere herein, the communication manager 150 may transmit, to a UE, first signaling associated with a first transport block, the first signaling indicating that the first transport block has a same HARQ identifier as a second transport block, wherein at least one of the first transport block and the second transport block are associated with SPS; and receive, from the UE, second signaling indicating an unsuccessful termination of a HARQ process associated with the second transport block in response to a failure of the UE to successfully decode the second transport block, the first transport block having the same HARQ identifier as the second transport block, or an NDI associated with the same HARQ identifier. Additionally or alternatively, the communication manager 150 may perform one or more other operations described herein.

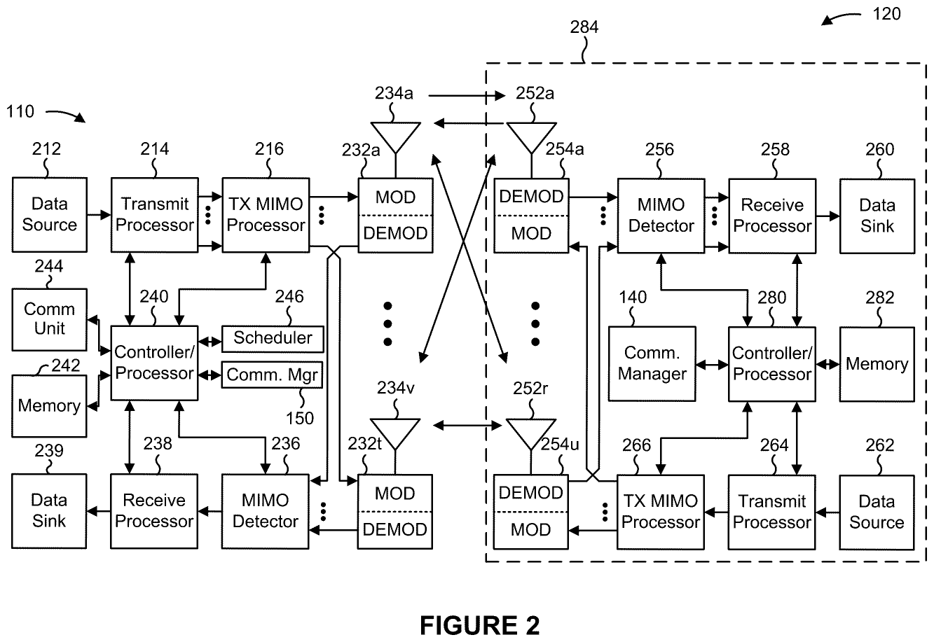

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform SPS or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

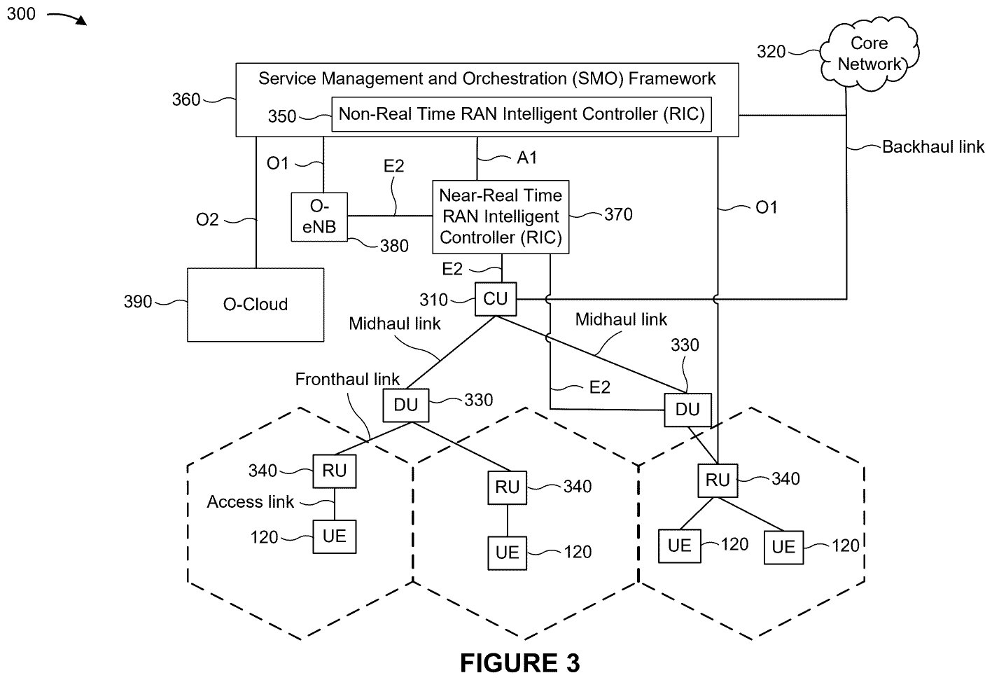

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 May communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

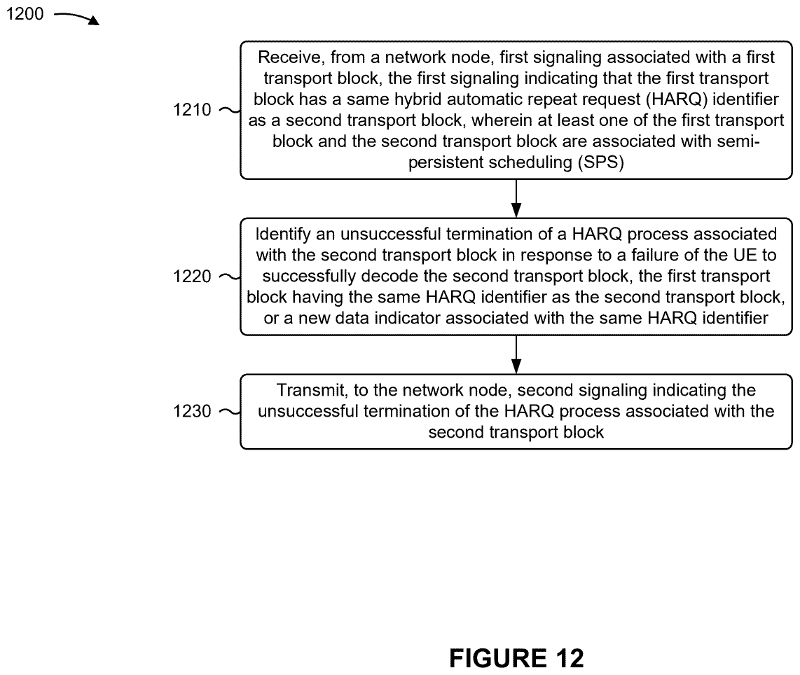

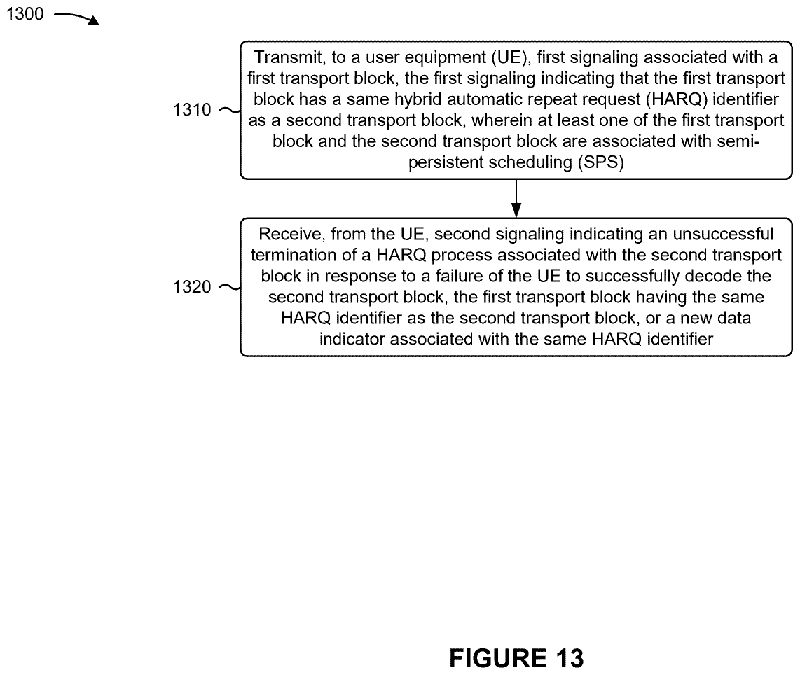

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with an unsuccessful termination of a HARQ process associated with an SPS transmission, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1200 of FIG. 12, process 1300 of FIG. 13, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1200 of FIG. 12, process 1300 of FIG. 13, or other processes as described herein. In some examples, executing instructions may include running the instructions, converting the instructions, compiling the instructions, and/or interpreting the instructions, among other examples.

In some aspects, the UE includes means for receiving, from a network node, first signaling associated with a first transport block, the first signaling indicating that the first transport block has a same HARQ identifier as a second transport block, wherein at least one of the first transport block and the second transport block are associated with SPS; means for identifying an unsuccessful termination of a HARQ process associated with the second transport block in response to a failure of the UE to successfully decode the second transport block, the first transport block having the same HARQ identifier as the second transport block, or an NDI associated with the same HARQ identifier; and/or means for transmitting, to the network node, second signaling indicating the unsuccessful termination of the HARQ process associated with the second transport block. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting, to a UE, first signaling associated with a first transport block, the first signaling indicating that the first transport block has a same HARQ identifier as a second transport block, wherein at least one of the first transport block and the second transport block are associated with SPS; and/or means for receiving, from the UE, second signaling indicating an unsuccessful termination of a HARQ process associated with the second transport block in response to a failure of the UE to successfully decode the second transport block, the first transport block having the same HARQ identifier as the second transport block, or an NDI associated with the same HARQ identifier. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

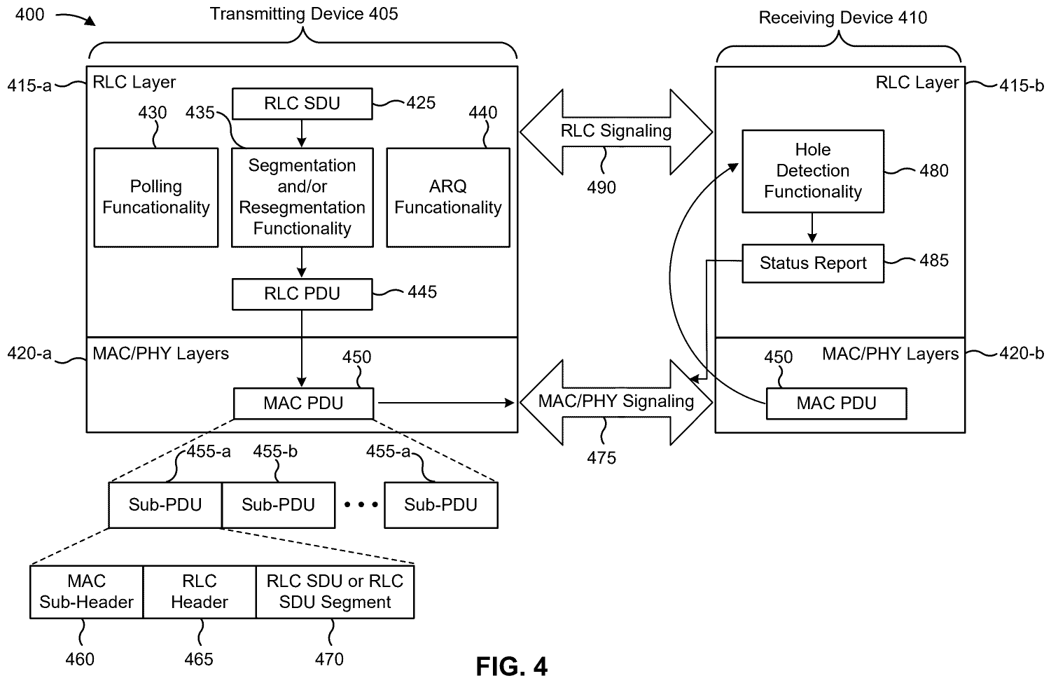

FIG. 4 is a diagram illustrating an example 400 associated with identifying unsuccessful terminations of HARQ processes, in accordance with the present disclosure. As shown in FIG. 4, a transmitting device 405 and a receiving device 410 may communicate with one another. For example, the transmitting device 405 may transmit, to the receiving device 410, the MAC protocol data unit (PDU) 450.

In some cases, the transmitting device 405 may correspond to a network node 110, the receiving device 410 may correspond to a UE 120, and the transmitting device 405 may transmit communications to the receiving device 410 via a downlink. In some other cases, the transmitting device 405 may correspond to a UE 120, the receiving device 410 may correspond to a network node 110, and the transmitting device 405 may transmit communications to the receiving device 410 via an uplink.

Both the transmitting device 405 and the receiving device 410 may include an RLC layer 415 and MAC/PHY layers 420 (for example, including a MAC layer, a PHY layer, or both a MAC layer and a PHY layer). Although not illustrated, the transmitting device 405 and the receiving device 410 may also include additional layers, such as PDCP layers, RRC layers, and/or SDAP layers. In the example 400, the RLC 415-a of the transmitting device 405 and the RLC layer 415-b of the receiving device 410 may exchange RLC signaling 490. Additionally, the MAC/PHY layers 420-a of the transmitting device 405 and the MAC/PHY layers 420-b of the receiving device 410 may exchange MAC/PHY signaling 475.

In the example 400, the RLC layer 415-a of the transmitting device 405 may receive the RLC SDU 425 from a PDCP layer of the transmitting device 405. The RLC layers 415 (for example, 415-a and 415-b) may have multiple different modes. In particular, the transmitting device 405 and the receiving device 410 may operate the RLC layers 415 in accordance with a transparent mode, an unacknowledged mode, or an acknowledged mode. In an example where the RLC layer 415-a is operating in accordance with the transparent mode, the transmitting device 405 may pass the RLC SDU 425 through the RLC layer 415-a (for example, from the PDCP layer to the MAC layer of the transmitting device 405) as an RLC PDU 445 without additional processing by the RLC layer 415-a. In another example where the RLC layer 415-a is operating in accordance with the unacknowledged mode, the transmitting device 405 may perform segmentation functionality (for example, of the segmentation and/or resegmentation functionality 435 illustrated in example 400), but may not perform ARQ functionality 440. In another example where the RLC layer 415-a is operating in accordance with the acknowledged mode, the transmitting device 405 may perform the segmentation and/or resegmentation functionality 435 and the ARQ functionality 440.

When operating the RLC layer 415-a in accordance with the acknowledgement mode, the transmitting device 405 may perform the segmentation and/or resegmentation functionality 435 to fit the RLC SDU 425 into available resources (for example, for transmission). For example, the transmitting device 405 may segment the RLC SDU 425 to generate multiple RLC SDU segments. The transmitting device 405 may perform re-segmentation functionalities (for example, of the segmentation and/or resegmentation functionality 435) to support the ARQ functionality 440, where an available payload size may change.

The RLC layer 415-a of the transmitting device 405 may generate the RLC PDU 445, which may include the RLC SDU 425. In some cases, the RLC PDU 445 may include one or multiple RLC SDUs 425 or one or multiple RLC SDU segments (for example, generated by the segmentation functionality of the segmentation and/or resegmentation functionality 435) associated with the RLC SDU 425. Each RLC SDU segment in the RLC PDU 445 may include a header that includes a sequence number associated with the RLC SDU segment. Then, the RLC layer 415-a may provide the RLC PDU 445 to the MAC/PHY layers 420-a of the transmitting device, and the MAC/PHY layers 420-a may receive a MAC PDU 450.

The MAC PDU 450 may correspond to a transport block (for example, transmitted from the transmitting device 405 to the receiving device via the MAC/PHY signaling 475). The MAC PDU 450 may include one or multiple sub-PDUs 455 (for example, MAC SDUs). Each sub-PDU 455 may include a MAC sub-header 460, an RLC header 465, and an RLC SDU or RLC SDU segment 470. In some examples, the RLC PDU 445 may correspond to the RLC header 465 and the RLC SDU or RLC SDU segment 470 in each sub-PDU 455. The RLC header 465 may include information related to the RLC SDU or RLC SDU segment 470. For example, the RLC header 465 may include a sequence number associated with the RLC SDU or RLC SDU segment 470, segmentation information associated with an RLC SDU segment of the RLC SDU or RLC SDU segments 470, and/or a segment offset associated with an RLC SDU segment of the RLC SDU or RLC SDU segments 470.

The MAC/PHY layers 420-a of the transmitting device 405 may transmit, via the MAC/PHY signaling 475, the MAC PDU 450 to the receiving device 410. The MAC/PHY layers 420-b of the receiving device 410 may provide the MAC PDU 450 to the RLC layer 415-b of the receiving device 410. The receiving device 410 may perform a HARQ process associated with the MAC PDU 450. For example, in cases where the receiving device 410 successfully decodes the MAC PDU 450, the receiving device 410 may transmit a HARQ ACK message to the transmitting device 405 via the MAC/PHY signaling 475. Additionally, in cases where the receiving device 410 fails to successful decode the MAC PDU 450, the receiving device 410 may transmit a HARQ NACK message to the transmitting device 405 via the MAC/PHY signaling 475. In response to receiving a HARQ NACK message from the receiving device 410, the transmitting device 405 may perform a retransmission associated with the MAC PDU 450. For example, the transmitting device 405 may retransmit a portion of the MAC PDU 450 (for example, that is selected based on or otherwise associated with the portion of the MAC PDU 450 that the receiving device 410 was unable to successfully decode). Upon receiving the retransmission from the transmitting device 405, the receiving device 410 may attempt to decode the MAC PDU 450 using a combination of the data received in the initial transmission of the transport block and the data received in the retransmission.

In some cases, the transmitting device 405 may continue to send retransmissions associated with the MAC PDU 450 until the transmitting device 405 receives a HARQ ACK message from the receiving device 410 (for example, indicating that the receiving device successfully decodes the MAC PDU 450). In response to receiving the HARQ ACK message from the receiving device 410, the transmitting device 405 may terminate the HARQ process. In some other cases, the transmitting device 405 may terminate the HARQ process without receiving a HARQ ACK message from the receiving device 410. For example, the transmitting device 405 may terminate the HARQ process after a quantity of retransmissions performed by the transmitting device 405 satisfies (for example, is equal to or greater than) a quantity threshold associated with a quantity of retransmissions.

In cases where the RLC layer 415-b of the receiving device 410 is operating in accordance with the acknowledgement mode, the receiving device 410 may additionally perform an ARQ process. For example, the RLC layer 415-b of the receiving device 410 may support the ARQ functionality 440. Here, the RLC layer 415-b of the receiving device 410 may have a hole detection functionality 480, which may enable the receiving device 410 to detect holes (for example, to detect one or more RLC SDU segments 470 in a MAC PDU 450 that the receiving device 410 has failed to decode). In some cases, the receiving device 410 may detect holes based on or otherwise associated with a sequence number associated with the RLC SDU or RLC SDU segments 470 (for example, included in the RLC header 465), segmentation information associated with the RLC SDU or RLC SDU segments 470 (for example, included in the RLC header 465, included in the MAC sub-header 460), and/or a segment offset associated with the RLC SDU or RLC SDU segments 470 (for example, included in the RLC header 465, included in the MAC sub-header 460). In some instances, the receiving device 410 may detect the holes with or without assistance from a lower layer (for example, MAC/PHY layers 420-b of the receiving device 410).

The receiving device 410 may detect holes associated with a transmission of the MAC PDU 450 based on or otherwise associated with a timer (for example, a t-Reassembly timer). For example, the receiving device 410 may identify one or more missing RLC SDUs or RLC SDU segments 470 based on or otherwise associated with the sequence numbers associated with RLC SDUs or RLC SDU segments 470 that have been successfully received and decoded. The receiving device 410 may initiate the timer in response to identifying that one or more RLC SDUs or RLC SDU segments 470 are missing. If, prior to an expiration of the timer, the receiving device 410 does successfully receive and decode the one or more missing RLC SDUs or RLC SDU segments 470 (for example, as part of a HARQ process associated with the MAC PDU 450), the receiving device 410 may reset the timer. Additionally, if the receiving device 410 does not successfully receive and decode the one or more missing RLC SDUs or RLC SDU segments 470 prior to the expiration of the timer, the receiving device 410 may generate and transmit a status report 485 to the transmitting device 405.

In one example, the receiving device may detect holes as part of the RLC process in instances of a HARQ NACK to HARQ ACK error. In this example, the receiving device 410 may transmit a HARQ NACK to the transmitting device 405, and the transmitting device 405 may interpret the HARQ NACK as a HARQ ACK. As a result, the transmitting device 405 may terminate the HARQ process (for example, may stop HARQ transmissions and/or retransmissions for the MAC PDU 450).

In the example 400, the receiving device 410 may detect NACK to ACK errors prior to an expiration of the timer associated with the hole detection functionality 480 (for example, prior to the expiration of the t-Reassembly timer). In particular, the receiving device 410 may detect the NACK to ACK errors based on or otherwise associated with detecting an unsuccessful termination of a HARQ process (for example, due to a NACK to ACK error) associated with the MAC PDU 450. Then, the receiving device 410 may report the unsuccessful termination of the HARQ process associated with the MAC PDU 450 to the transmitting device 405.

In some cases, the receiving device 410 may identify and report unsuccessful HARQ process terminations in instances of SPS transmissions (for example, in cases where the MAC PDU 450 is transmitted via an SPS occasion). For example, the receiving device 410 may identify the unsuccessful termination of a HARQ process in instances where the receiving device 410 receives control information scheduling a transmission or receives an SPS having a same HARQ identifier associated with a previously-received transport block that the receiving device 410 has not successfully decoded. Additionally or alternatively, the transmitting device 405 may configure the value of NDIs associated with non-SPS transmissions to be based on or otherwise associated with SPS transmissions associated with the same HARQ identifier as the non-SPS transmission. Here, the receiving device 410 may identify an unsuccessful termination of a HARQ process in response to or based on an NDI associated with a non-SPS transmission being different from an expected value of the NDI. The receiving device 410 may then report the unsuccessful termination of the HARQ process and the transmitting device 405 may initiate an ARQ process (for example, in response to receiving the report from the receiving device 410 that indicates the unsuccessful termination of the HARQ process).

The status report 485 may be associated with a timer (for example, a t-StatusProhibit timer). Here, the receiving device 410 may refrain from transmitting the status report 485 until the timer expires. In some cases, the receiving device 410 waiting until the timer expires to transmit the status report 485 may decrease a periodicity associated with the receiving device 410 sending status reports 485. That is, after the receiving device 410 sends a status report 485, the receiving device 410 may reset and start (for example, initiate) the timer and may be unable to send another status report 485 until an expiration of the timer. The status report 485 may include RLC ACK and/or RLC NACK for certain sequence numbers (for example, associated with the MAC PDU 450).

The receiving device 410 may transmit a status report 485 in response to a polling request from the transmitting device 405. For example, the transmitting device 405 may include a polling functionality 430 at the RLC layer 415-a. In this example, the transmitting device may transmit, to the receiving device 410 (for example, via the RLC signaling 490, via the MAC/PHY signaling 475) a polling request triggering the receiving device 410 to transmit the status report 485 to the transmitting device 405. The transmitting device 405 may transmit the polling request based on or otherwise associated with a quantity of MAC PDUs 450 transmitted to the receiving device 410. For example, the transmitting device 405 may transmit the polling request after transmitting a certain quantity of MAC PDUs 450 (for example, as indicated by a variable such as a pollPDU variable). In another case, the transmitting device 405 may transmit the polling request based on or otherwise associated with a quantity of bytes transmitted (for example, via one or more MAC PDUs 450) to the receiving device 410. For example, the transmitting device 405 may transmit the polling request after transmitting a certain quantity of bytes (for example, as indicated by a variable such as a pollByte variable).

The receiving device 410 may transmit the status report 485 via the MAC/PHY signaling 475 or, in some other cases, via the RLC signaling 490. In response to receiving the status report 485, the transmitting device 405 may perform an ARQ process (for example, using the ARQ functionality 440 of the RLC layer 415-a). For example, the transmitting device 405 may retransmit any of the RLC SDU or RLC SDU segments 470 that correspond to a sequence number indicated as not successfully received and decoded in the status report 485. In some cases, the transmitting device 405 may continue transmitting retransmissions of any RLC SDUs or RLC SDU segments 470 until the receiving device 410 indicates that the RLC SDUs or RLC SDU segments 470 have been successfully received and decoded (for example, via an RLC ACK for the sequence numbers associated with the RL SDUs or RLC SDU segments 470). Additionally or alternatively, the transmitting device 405 may refrain from transmitting a retransmission of an RLC SDU or RLC SDU segment 470 in instances where a quantity of retransmissions associated with that RLC SDU or RLC SDU segment 470 is greater than a threshold (for example, a maxRetxThreshold).

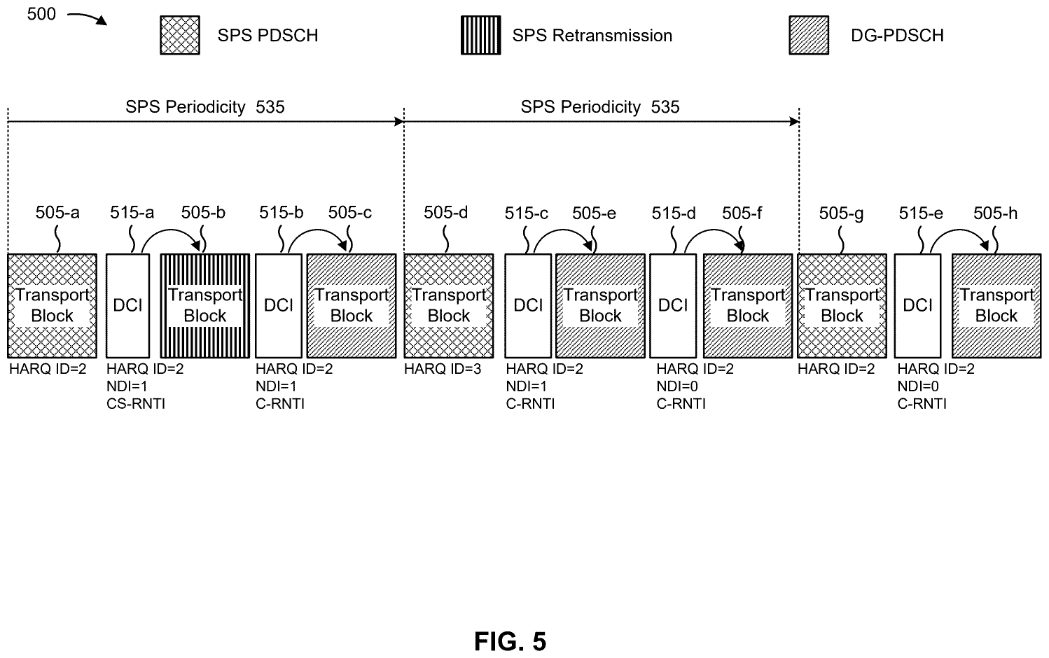

FIG. 5 is a diagram illustrating an example 500 of signaling exchanged between a transmitting and receiving device (for example, between a network node and a UE) in accordance with the present disclosure.

In the example 500, the network node may transmit some transport blocks 505 via an SPS PDSCH, such as via SPS occasions. For instance, the network node may transmit transport blocks 505-a, 505-d, and 505-g via SPS occasions in the PDSCH. Additionally, the network node may transmit other transport blocks 505 via dynamically scheduled PDSCH resources. For example, the network node may transmit the transport blocks 505-b, 505-c, 505-e, 505-f, and 505-h via resources that are dynamically granted (such as by the DCIs 515-a, 515-b, 515-c, 515-d, and 515-e, respectively).

For SPS transmissions (for example, for SPS-PDSCH), resources may be periodically configured (such as in an SPS configuration indicated by RRC signaling) and the network node may activate an SPS configuration via DCI signaling. Additionally, the network node may configure a set of HARQ identifiers on a per-SPS configuration basis. Then, within a set of SPS transmissions (such as within a set of transport blocks 505 that are transmitted according to one SPS configuration), the HARQ identifier may be incremented for each SPS occasion or periodicity. Additionally or alternatively, the HARQ identifier may be incremented based on or otherwise associated with a slot number of the PDSCH. In the example 500, the transport blocks 505-a, 505-d, and 505-g may be associated with a same SPS configuration. Here, the SPS configuration may indicate resources having the SPS periodicity 535, and may indicate that the transport blocks 505 transmitted via the SPS occasions associated with the SPS configuration may have HARQ identifiers within the set of {2, 3}. The first transport block 505-a may have a HARQ identifier of 2, and, in accordance with incrementing the HARQ identifier for each SPS occasion or periodicity within a set of SPS transmissions, the second transport block 505-d associated with the SPS configuration may have an incremented HARQ identifier of 3. The next transport block 505-g associated with the SPS configuration may have another incremented HARQ identifier (which is incremented from 3, back to 2 based on or otherwise associated with the SPS configuration indicating that the HARQ identifiers include {2, 3}) of 2.

For dynamically scheduled PDSCH transmissions, which may be referred to as DG-PDSCH transmissions, a HARQ identifier associated with each transport block 505 may be indicated by a DCI 515. For example, the DCI 515-a may indicate that the transport block 505-b is associated with a HARQ identifier of 2, the DCI 515-b may indicate that that the transport block 505-c is associated with the HARQ identifier of 2, the DCI 515-c may indicate that the transport block 505-e is associated with the HARQ identifier of 2, the DCI 515-d may indicate that the transport block 505-f is associated with the HARQ identifier of 2, and the DCI 515-e may indicated that the transport block 505-h is associated with the HARQ identifier of 2.

DG-PDSCH transmissions may be associated with a C-RNTI or a CS-RNTI. Transport blocks 505 that are associated with a C-RNTI (or, in other cases, an MCS-C-RNTI) may not be associated with any SPS transmissions, and may be referred to as non-SPS transmissions. These DG-PDSCH transport blocks 505 that are associated with the C-RNTI or MCS-C-RNTIs may be either initial transmissions or retransmissions, and the DCI 515 associated with that transport block 505 may indicate whether the transport block 505 includes an initial transmission or a retransmission by toggling or not toggling an NDI.

Transport blocks 505 that are associated with a CS-RNTI may include retransmissions of SPS-PDSCH transmissions. In some cases, DCIs that schedule retransmissions of SPS-PDSCH transmissions may include an NDI of 1, and a CRC that is scrambled by the CS-RNTI associated with the transport block 505. Additionally, the network node may not toggle the NDI for SPS retransmissions.

In some wireless communication networks, a network node may use the same HARQ identifiers for SPS transmissions (such as for transport blocks 505 transmitted via SPS occasions on the PDSCH) and DG-PDSCH transmissions (such as for transport blocks 505 transmitted via dynamically granted resources on the PDSCH). In these examples, an NDI associated with SPS transmissions is always toggled, which may indicate that the transport blocks 505 carried in SPS occasions corresponds to initial or new transmissions. In the example 500, an NDI associated with the transport block 505-a and 505-g (which are both associated with the HARQ identifier of 2) may indicate that the transport blocks 505-a and 505-g are new transport blocks 505 (instead of retransmissions).

Additionally, for DG-PDSCHs associated with C-RNTIs, if a previous transport block 505 associated with the same HARQ identifier is a downlink assignment received for the MAC entity's CS-RNTI (such as an SPS retransmission) or a configured downlink assignment (such as an SPS-PDSCH), the NDI may be interpreted as toggled independent of a value of the NDI. In the example 500, the transport block 505-c may be associated with an NDI of 1, which may be a same value of the NDI associated with the transport block 505-b, which may be an SPS retransmission (such as a retransmission of the transport block 505-a). However, the UE and network node may interpret the NDI associated with the transport block 505-c as toggled independently of the value of the NDI being the same (and not toggled) with respect to the previously-received transport block 505-b associated with the same HARQ identifier. Additionally, the transport block 505-h may be associated with an NDI of 0, and the UE and network node may interpret the NDI as being toggled regardless of the value of the NDI.

In some instances, the NDI for SPS-PDSCH may not have a relation to a previously received or subsequently received PDSCH having a same HARQ identifier (such as due to interpreting the NDI as being toggled or incremented by 1 modulo 2 independently of the actual value of the NDI). Accordingly, the UE may be unable to rely on the value indicated by an NDI for SPS-PDSCH to determine whether a previously or subsequently transmitted transport block associated with a same HARQ identifier is associated with an unsuccessfully terminated HARQ process.

Instead, the UE may identify an unsuccessful termination of a HARQ process in response to or based on receiving control information scheduling a transmission or receiving an SPS having a same HARQ identifier associated with a previously-received transport block 505 that the UE has not successfully decoded. Additionally or alternatively, the network node may configure the value of NDIs associated with non-SPS transmissions to be based on or otherwise associated with SPS transmissions associated with the same HARQ identifier as the non-SPS transmission. Here, the UE may identify an unsuccessful termination of a HARQ process responsive to, based on, or otherwise associated with an NDI associated with a non-SPS transmission being different from an expected value of the NDI. The UE may then report the unsuccessful termination of the HARQ process and the network node may initiate an ARQ process.

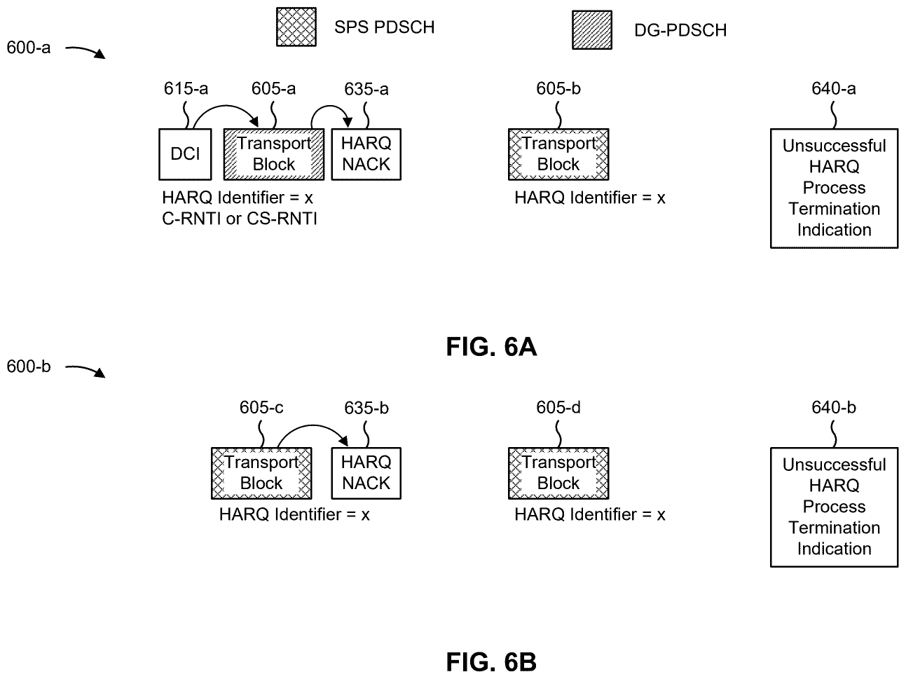

FIGS. 6A and 6B are diagrams illustrating examples 600 of signaling exchanged between a transmitting and receiving device (for example, between a network node and a UE) in accordance with the present disclosure.

In the examples 600, a UE may fail to successfully decode a transport block 605 (such as the transport block 605-a in the example 600-a and the transport block 605-c in the example 600-b) and may transmit, to the network node, a HARQ NACK 635 (such as the HARQ NACK 635-a in the example 600-a and the HARQ NACK 635-b in the example 600-b). The UE may subsequently identify an unsuccessful termination of a HARQ process associated with the transport blocks 605-a and 605-c, and may transmit, to the network node, signaling including an unsuccessful HARQ process termination indication 640.

In the examples 600, HARQ identifiers may or may not be shared between C-RNTI and CS-RNTIs. That is, the network node may indicate, to the UE (such as via RRC configuration) whether HARQ identifiers may be shared between C-RNTI and CS-RNTIs. For example, the network node may indicate a set of HARQ identifiers for CS-RNTI, and the set of HARQ identifiers may be RRC configured on a per SPS configuration basis. Additionally, the network node may dynamically indicate HARQ identifiers (such as via DCI signaling) for C-RNTI. The network node may indicate whether HARQ identifiers are shared between C-RNTI and CS-RNTIs per component carrier (for example, some component carriers may be configured with shared HARQ identifiers while other component carriers may be configured without shared HARQ identifiers), per HARQ identifier (for example, some HARQ identifiers may be shared, while other HARQ identifiers may not be shared), or per SPS configuration (such as for the HARQ identifiers configured for each SPS configuration).

In the example 600-a, the network node may transmit DCI 615-a with scheduling information for a first transport block 605-a. The DCI 615-a may additionally indicate that the transport block 605-a is associated with the HARQ identifier of ‘x’ and that the transport block 605-a is associated with an RNTI (such as a C-RNTI or CS-RNTI). The UE may be unable to successfully decode the transport block 605-a, and may transmit the HARQ NACK 635-a to indicate, to the network node, the failure of the UE to successfully decode the transport block 605-a.

In the example 600-b, the network node may transmit a first transport block 605-c associated with a HARQ identifier of ‘x.’ In some cases, the network node may transmit the first transport block 605-c via an SPS occasion (for example, the transport block 605-c may be an SPS-PDSCH). The UE may be unable to successfully decode the transport block 605-c, and may transmit the HARQ NACK 635-b to indicate, to the network node, the failure of the UE to successfully decode the transport block 605-c.

In both examples 600, the network node may transmit, after the UE transmits the HARQ NACK 635 for a transport block 605 associated with the HARQ identifier of ‘x,’ a second transport block 605 having the same HARQ identifier ‘x’ (such as the transport block 605-b in the example 600-a and the transport block 605-d in the example 600-b). The network node may transmit the second transport block 605 via an SPS occasion, and the second transport blocks 605-b and 605-d may correspond to SPS-PDSCH transmissions. In some instances, transport blocks 605 transmitted via SPS occasions may include initial transmissions, and may not include retransmissions. Accordingly, the UE may determine that the second transport blocks 605-b and 605-d do not correspond to retransmissions of the first transport blocks 605-a and 605-c, respectively.

The UE may identify the unsuccessful termination of the HARQ process associated with the transport blocks 605-a and 605-c in response to or based on receiving an SPS PDSCH (such as the transport blocks 605-b and/or 605-d) while the UE has not successfully decoded a previously-received transport block 605 (such as the transport blocks 605-a and/or 605-c) having the same HARQ identifiers ‘x.’

In response to identifying the unsuccessful termination of the HARQ process, the UE may transmit, to the network node, an unsuccessful HARQ process termination indication 640. More specifically, the UE may transmit the unsuccessful HARQ process termination indication 640-a in the example 600-a (for example, based on or otherwise associated with identifying the unsuccessful termination of the HARQ process associated with the transport block 605-a). Additionally, the UE may transmit the unsuccessful HARQ process termination indication 640-b in the example 600-b (for example, based on or otherwise associated with identifying the unsuccessful termination of the HARQ process associated with the transport block 605-c).

In instances that the unsuccessful HARQ process termination indication 640 indicates the unsuccessful HARQ process termination associated with a CS-RNTI (such as in cases when the transport block 605-a is associated with a CS-RNTI and in the example 600-b, where the transport block 605-c is an SPS PDSCH associated with a CS-RNTI), the unsuccessful HARQ process termination indication 640 may or may not include an NDI.

In one example, the unsuccessful HARQ process termination indication 640 may not include an NDI field (such as to report an NDI value). Additionally or alternatively, the unsuccessful HARQ process termination indication 640 may include an NDI field, and the UE may set the NDI field to a default value (such as to a ‘0,’ or a ‘1’). In this example, the unsuccessful HARQ process termination indication 640 may include a bit that indicates that the unsuccessful HARQ process termination relates to a CS-RNTI. Here, setting the bit to a first value may indicate that the unsuccessful HARQ process termination relates to the CS-RNTI, and setting the bit a to a second value may indicate that the unsuccessful HARQ process termination relates to a C-RNTI.

In another example, the unsuccessful HARQ process termination indication 640 may include an NDI field indicating a first NDI value (such as of ‘0’) in instances where the unsuccessful HARQ process termination relates to an SPS PDSCH and indicating a second NDI value (such as of ‘1’) in instances where the unsuccessful HARQ process termination relates to an SPS retransmission. Here, the UE may report an NDI value literally, but may not report a relationship to an NDI of a DCI having the CRC scrambled with the C-RNTI. Additionally, the NDI may be ‘0’ in SPS activation DCI and the NDI may be ‘1’ in DCI scheduling SPS retransmissions.

In another example, the unsuccessful HARQ process termination indication 640 may include an NDI field indicating a value that is based on or otherwise associated with a maintained NDI procedure. For example, the UE may increment the NDI value by 1 (modulo 2 or modulo 2k) in response to receiving any SPS PDSCH that has a same HARQ identifier as a previous instance of the NDI.

The unsuccessful HARQ process termination indication 640 may additionally include a include a time stamp associated with the unsuccessfully terminated HARQ process. The time stamp may correspond to a slot number, a subframe number, and/or a system frame number. In some cases, the time stamp may correspond to a time that the control information scheduling a transport block 605 associated with the unsuccessfully terminated HARQ process is transmitted or received, a time that the transport block 605 associated with the unsuccessfully terminated HARQ process is transmitted or received, a time that the UE transmits a HARQ NACK 635 associated with the unsuccessfully terminated HARQ process, a time that control information scheduling another transport block 605 associated with the same HARQ identifier (for example, and received while the UE has not successfully decoded the transport block 605 associated with the unsuccessfully terminated HARQ process) is transmitted or received (which may correspond to the time when the UE detects the unsuccessful HARQ process termination), and/or a time that the unsuccessfully terminated HARQ process is indicated (for example, to the network node) for a first time.

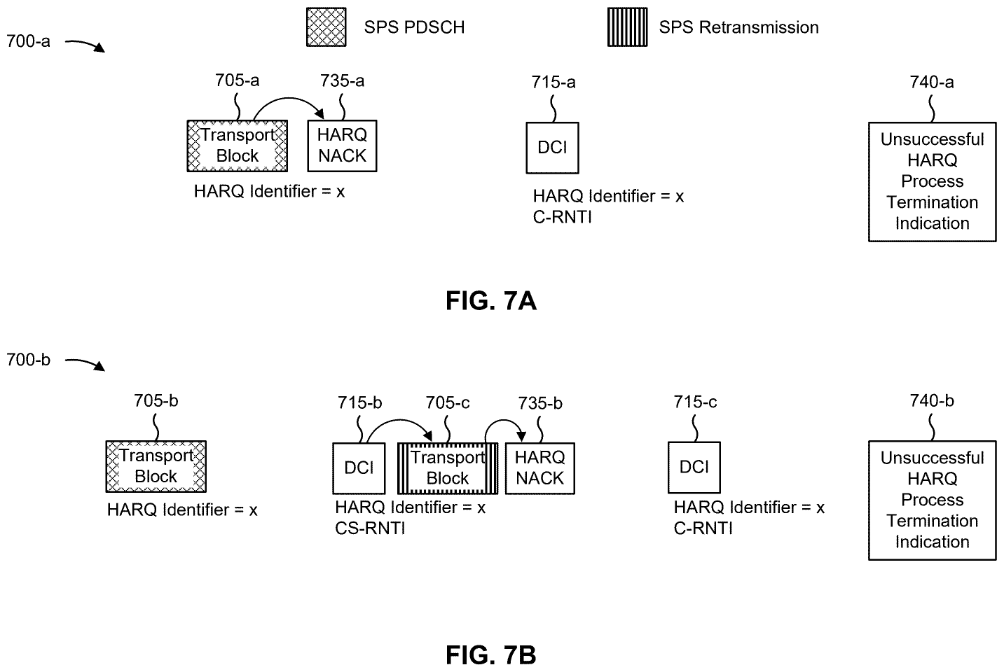

FIGS. 7A and 7B are diagrams illustrating examples 700 of signaling exchanged between a transmitting and receiving device (for example, between a network node and a UE) in accordance with the present disclosure.

In the examples 700, a UE may fail to successfully decode a transport block 705 (such as the transport block 705-a in the example 700-a and the transport block 705-c in the example 700-b) and may transmit, to the network node, a HARQ NACK 735 (such as the HARQ NACK 735-a in the example 700-a and the HARQ NACK 735-b in the example 700-b). The UE may subsequently identify an unsuccessful termination of a HARQ process associated with the transport blocks 705-a and 705-c, and may transmit, to the network node, signaling including an unsuccessful HARQ process termination indication 740-a and 740-b, respectively.

In the examples 700, HARQ identifiers may be shared between C-RNTI and CS-RNTIs. That is, the network node may indicate, to the UE (such as via RRC configuration) HARQ identifiers may be shared between C-RNTI and CS-RNTIs. In instances where the network node indicates that HARQ identifiers may not be shared between C-RNTI and CS-RNTIs, the UE may not identify the unsuccessful termination of the HARQ processes in accordance with the examples 700.

In the example 700-a, the network node may transmit the transport block 705-a via an SPS occasion (that is, the transport block 705-a may be an SPS PDSCH). Additionally, the transport block 705-a may be associated with the HARQ identifier of ‘x’ and a CS-RNTI. The UE may be unable to successfully decode the transport block 705-a, and may transmit the HARQ NACK 735-a to indicate, to the network node, the failure of the UE to successfully decode the transport block 705-a.

In the example 700-b, the network node may transmit a first transport block 705-b via an SPS occasion (that is, the transport block 705-b may be an SPS PDSCH). Additionally, the transport block 705-b may be associated with the HARQ identifier of ‘x’ and a CS-RNTI. Then, the network node may transmit the DCI 715-b including control information scheduling the transport block 705-c. The DCI 715-b may additionally indicate that the transport block 705-c is associated with the HARQ identifier of ‘x’ and that the transport block 705-c is associated with CS-RNTI (for example, the transport block 705-c is an SPS retransmission of the transport block 705-b). The UE may be unable to successfully decode the transport block 705-c, and May transmit the HARQ NACK 735-b to indicate, to the network node, the failure of the UE to successfully decode the transport block 705-c.

In both examples 700, the network node may transmit, after the UE transmits the HARQ NACK 735 for a transport block 705 associated with the HARQ identifier of ‘x,’ a DCI 715 scheduling a transport block 705 having a same HARQ identifier ‘x.’ The DCI 715 (such as the DCI 715-a and 715-c) may additionally indicate that the scheduling information is for a transport block 705 associated with a C-RNTI. In some cases, the DCI 715 may indicate that the scheduling information is for the transport block 705 associated with the C-RNTI by including a CRC that is scrambled with the C-RNTI. Because the DCI 715-a and 715-c schedules a transport block 705 associated with a C-RNTI, the UE may determine that the DCI 715-a and 715-c is not scheduling a retransmission of the SPS PDSCH (such as the transport block 705-a or 705-c). Accordingly, the UE may identify an unsuccessful termination of the HARQ processes associated with the transport blocks 705-a and 705-c.

The UE may identify the unsuccessful termination of the HARQ process associated with the transport blocks 705-a and 705-c in response to receiving a DCI 715 having a CRC scrambled by C-RNTI (for example, instead of a CRC scrambled by a CS-RNTI) while the UE has not successful decoded a previously received transport block 705 associated with a CS-RNTI having the same HARQ identifier ‘x’.

In instances that the unsuccessful HARQ process termination indication 740 indicates the unsuccessful HARQ process termination associated with a CS-RNTI (such as in cases when the transport block 705-a is associated with a CS-RNTI and in the example 700-b, where the transport block 705-c is an SPS PDSCH associated with a CS-RNTI), the unsuccessful HARQ process termination indication 740 may or may not include an NDI.

In one example, the unsuccessful HARQ process termination indication 740 may not include an NDI field (such as to report an NDI value). Additionally or alternatively, the unsuccessful HARQ process termination indication 740 may include an NDI field, and the UE may set the NDI field toa default value (such as to a ‘0,’ or a ‘1’). In this example, the unsuccessful HARQ process termination indication 740 may include a bit that indicates that the unsuccessful HARQ process termination relates to a CS-RNTI. Here, setting the bit to a first value may indicate that the unsuccessful HARQ process termination relates to the CS-RNTI, and setting the bit a to a second value may indicate that the unsuccessful HARQ process termination relates to a C-RNTI.

In another example, the unsuccessful HARQ process termination indication 740 may include an NDI field indicating a first NDI value (such as of ‘0’) in instances where the unsuccessful HARQ process termination relates to an SPS PDSCH and indicating a second NDI value (such as of ‘1’) in instances where the unsuccessful HARQ process termination relates to an SPS retransmission. Here, the UE may report an NDI value literally, but may not report a relationship to an NDI of a DCI having the CRC scrambled with the C-RNTI. Additionally, the NDI may be ‘0’ in SPS activation DCI and the NDI may be ‘1’ in DCI scheduling SPS retransmissions.

In another example, the unsuccessful HARQ process termination indication 740 may include an NDI field indicating a value that is based on or otherwise associated with a maintained NDI procedure. For example, the UE may increment the NDI value by 1 (modulo 2 or modulo 2k) in response to receiving any SPS PDSCH that has a same HARQ identifier as a previous instance of the NDI.

The unsuccessful HARQ process termination indication 740 may additionally include a include a time stamp associated with the unsuccessfully terminated HARQ process. The time stamp may correspond to a slot number, a subframe number, and/or a system frame number. In some cases, the time stamp may correspond to a time that the control information scheduling a transport block 705 associated with the unsuccessfully terminated HARQ process is transmitted or received, a time that the transport block 705 associated with the unsuccessfully terminated HARQ process is transmitted or received, a time that the UE transmits a HARQ NACK 735 associated with the unsuccessfully terminated HARQ process, a time that control information scheduling another transport block 705 associated with the same HARQ identifier (for example, and received while the UE has not successfully decoded the transport block 705 associated with the unsuccessfully terminated HARQ process) is transmitted or received (which may correspond to the time when the UE detects the unsuccessful HARQ process termination), and/or a time that the unsuccessfully terminated HARQ process is indicated (for example, to the network node) for a first time.

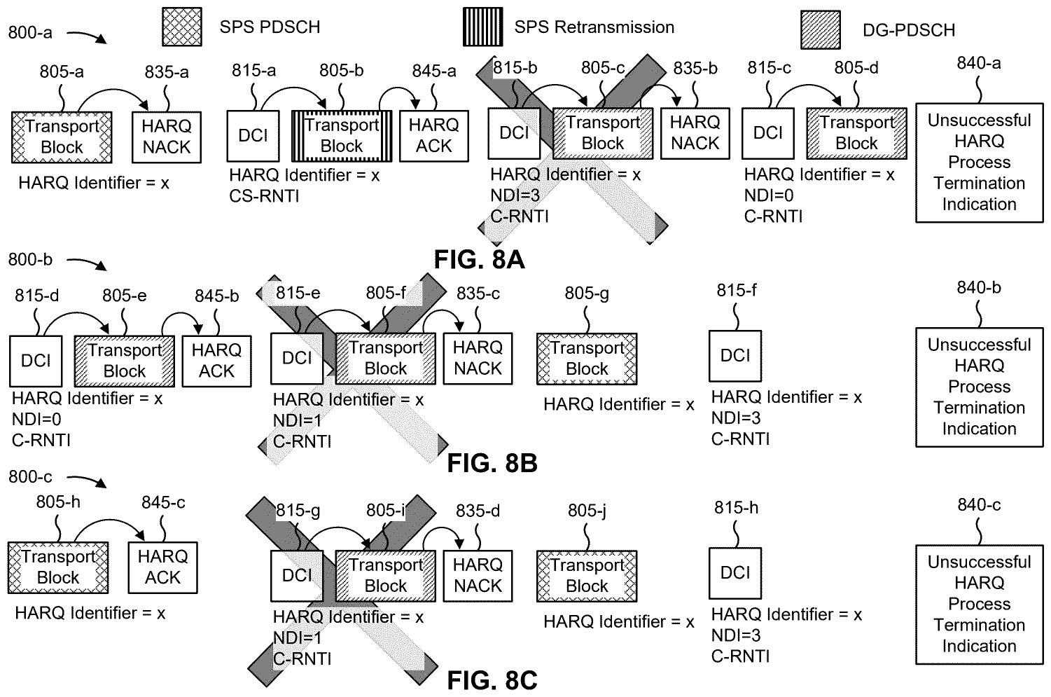

FIGS. 8A through 8C are diagrams illustrating examples 800 of signaling exchanged between a transmitting and receiving device (for example, between a network node and a UE) in accordance with the present disclosure.

In the examples 800, a UE may fail to detect or decode a DCI 815 that schedules a new or initial transmission of a transport block (such as the DCI 815-b scheduling the transport block 805-c, the DCI 815-e scheduling the transport block 805-f, and the DCI 815-g scheduling the transport block 805-i). In response to failing to detect or decode the DCI 815, the UE may indicate a HARQ NACK 835 to the network node. In some cases, the UE may indicate the HARQ NACK 835 by transmitting a HARQ NACK 835. Additionally or alternatively, the UE may indicate the HARQ NACK 835 may refraining from transmitting any HARQ feedback. In either case, the network node may incorrectly interpret the HARQ NACKs 835 (such as the HARQ NACKs 835-b, 835-c, and 835-d) as a HARQ ACK, which may result in an unsuccessful termination of a HARQ process associated with the transport blocks 805-c, 805-f, and 805-i.

In cases that the NDI values associated with SPS transmissions are configured independently as NDI values associated with non-SPS transmissions, the UE may be unable to identify the NACK to ACK error (and the resulting unsuccessful termination of the HARQ process) in instances where one or more of the transport blocks are associated with SPS transmissions. However, in the example 800, the NDIs may be incremented by 1 for SPS PDSCH transmissions (such as for transport blocks 805 that are associated with CS-RNTIs). Accordingly, a UE may determine if there are any missing NDIs (such as NDIs associated with SPS PDSCH transmissions and/or NDIs associated with non-SPS transmissions) in response to a gap between an expected NDI value and an NDI value indicated by a DCI 815.

In the example 800, the UE may determine if there are one or more unsuccessful HARQ process terminations for a given HARQ identifier (such as for HARQ identifier ‘x’) by comparing the gap in NDI for C-RNTI with a quantity of SPS PDSCH transmissions detected between the C-RNTIs. For example, the UE may identify an expected value of the NDI based on or otherwise associated with a quantity of SPS PDSCH transmissions having a same HARQ identifier that the UE detects between NDIs indicated by two DCIs 815 that have a CRC scrambled by C-RNTI (such as DCIs 815 that are scheduling non-SPS transmissions). For example, the if y SPS PDSCH transmissions having the same HARQ identifier have been detected between NDIs indicated by two DCIs 815, the UE may identify an expected NDI value x of y+1. If an NDI value indicated by an NDI field in a DCI 815 is different than the expected NDI value x, the UE may identify a quantity of unsuccessfully terminated HARQ processes, where the quantity is equivalent to x-y-1.

In some cases, a UE may not increment the expected value of the NDI value x in response to receiving any SPS retransmissions. That is, the UE may refrain from incremented the expected value of the NDI x in response to receiving SPS retransmissions, and may increment the value of the expected value of the NDI x in response to receiving initial SPS PDSCH transmissions. The UE may additionally perform a modulo operation to identify the expected value carried in an NDI field of the DCI 815. For example, the UE may perform a modulo 2 operation on the expected value of the NDI x in instances where the NDI field in the DCI 815 includes 1 bit and the UE may perform a modulo 2^{k} operation on the expected value of the NDI x in instances where the NDI field in the DCI 815 includes k bits. In the examples 800, the UE may perform a modulo 4 operation.

In the examples 800, the UE may identify the unsuccessful terminations of the HARQ processes associated with the transport blocks 805-c, 805-f, and 805-i based on or otherwise associated with a difference between the expected value of the NDI and the value of the NDI indicated by an NDI field in the dci 815. Then, the UE may report the unsuccessful terminations of the HARQ processes via the unsuccessful HARQ process termination indications 840-a, 840-b, and 840-c. In some cases, the UE may indicate, within the unsuccessful HARQ process termination indication 840, that the expected value of the NDI is different from the value of the NDI indicated by the DCI 815.

In the examples 800, HARQ identifiers may be shared between C-RNTI and CS-RNTIs. That is, the network node may indicate, to the UE (such as via RRC configuration) HARQ identifiers may be shared between C-RNTI and CS-RNTIs. In instances where the network node indicates that HARQ identifiers may not be shared between C-RNTI and CS-RNTIs, the UE may not identify the unsuccessful termination of the HARQ processes in accordance with the examples 800.

In the example 800-a, the network node may transmit a first transport block 805-a via an SPS occasion (for example, the first transport block 805-a may be an SPS PDSCH transmission), and the UE may fail to successfully decode the transport block 805-a. Accordingly, the UE may transmit the HARQ NACK 835-a to indicate the failure of the UE to successfully decode the transport block 805-a. As part of a HARQ process for the transport block 805-a, the network node may schedule a retransmission of the transport block 805-a via the DCI 815-a, which may schedule the transport block 805-b (which may include the SPS retransmission associated with the transport block 805-a). The UE may successfully receive and decode the transport block 805-b, and may therefore transmit the HARQ ACK 845-a indicating that the UE successfully decodes the transport block 805-b.

Then, the network node may transmit the DCI 815-b scheduling the transport block 805-c, but the UE may miss the transmission of the DCI 815-b and the transport block 805-c (for example, the UE may not detect or decode the DCI 815-b or the transport block 805-c). The transport block 805-c may be associated with a same HARQ identifier ‘x’ as the previous transport blocks 805-a and 805-b, and may be associated with a C-RNTI. In response to failing to detect or decode the DCI 815-b, the UE may indicate a HARQ NACK 835-b to the network node.

However, due to a NACK to ACK error, the network node may unsuccessfully terminate the HARQ process associated with the transport block 805-c and may transmit another DCI 815-c scheduling another transport block 805-d (such as an initial transmission of the transport block 805-d) associated with the same HARQ identifier X.

The UE may identify the unsuccessful termination of the HARQ process associated with the transport block 805-c in response to the expected value of the NDI indicated by the DCI 815-c being different from the NDI of 3 indicated by the DCI 815-c. For example, a previously NDI for a C-RNTI associated with the HARQ identifier ‘x’ (such as an NDI indicated by a DCI received prior to a reception of the transport block 805-a) may indicate an NDI of ‘1.’ The UE may increment the expected NDI value in response to receiving the transport block 805-a (since the transport block 805-a is associated with the same HARQ identifier and includes an initial SPS PDSCH) and may refrain from incrementing the expected NDI value in response to receiving the transport block 805-b (since the transport block 805-b is a retransmission). Additionally, because the UE does not detect the DCI 815-b or the transport block 805-c, the UE may not increment the expected NDI value in response to the network node transmitting the DCI 815-b. Therefore, the UE may expect that the NDI field in the DCI 815-c indicates a value of 3. However, because the NDI field in the DCI 815-c indicates a value of 0, the UE may identify that there is 1 missing NDI (corresponding to a single unsuccessfully terminated HARQ process). Here, the UE may transmit the unsuccessful HARQ process termination indication 840-a in response to identifying the unsuccessfully terminated HARQ process.

In the example 800-b, the network node may transmit DCI 815-d with scheduling information for a first transport block 805-e. The DCI 815-d may additionally indicate that the transport block 805-e is associated with the HARQ identifier of ‘x’ and that the transport block 805-e is associated with a C-RNTI. The UE may be successfully decode the transport block 805-e, and may transmit the HARQ ACK 845-b to indicate, to the network node, the successful decoding of the transport block 805-e.

Then, the network node may transmit the DCI 815-e scheduling the transport block 805-f, but the UE may miss the transmission of the DCI 815-e and the transport block 805-f (for example, the UE may not detect or decode the DCI 815-e or the transport block 805-f). The transport block 805-f may be associated with a same HARQ identifier ‘x’ as the previous transport block 805-e, and may be associated with a C-RNTI. In response to failing to detect or decode the DCI 815-e, the UE may indicate a HARQ NACK 835-c to the network node.

However, due to a NACK to ACK error, the network node may unsuccessfully terminate the HARQ process associated with the transport block 805-c and may transmit another transport block 805-g associated with the same HARQ identifier ‘x,’ which may be an SPS PDSCH transmitted via an SPS occasion. Then, the network node may additionally transmit the DCI 815-f scheduling another transport block 805 (such as an initial transmission of the transport block 805) associated with the same HARQ identifier ‘x.’

The UE may identify the unsuccessful termination of the HARQ process associated with the transport block 805-f in response to the expected value of the NDI indicated by the DCI 815-f being different from the NDI of 3 indicated by the DCI 815-f. The UE may increment the expected NDI value (such as from the NDI value of 0 indicated by the DCI 815-d) in response to receiving the transport block 805-g (since the transport block 805-g is associated with the same HARQ identifier and includes an initial SPS PDSCH). Additionally, because the UE does not detect the DCI 815-e or the transport block 805-f, the UE may not increment the expected NDI value in response to the network node transmitting the DCI 815-e. Therefore, the UE may expect that the NDI field in the DCI 815-f indicates a value of 2. However, because the NDI field in the DCI 815-f indicates a value of 3, the UE may identify that there is 1 missing NDI (corresponding to a single unsuccessfully terminated HARQ process). Here, the UE may transmit the unsuccessful HARQ process termination indication 840-b in response to identifying the unsuccessfully terminated HARQ process.

In the example 800-c, the network node may transmit a first transport block 805-h via an SPS occasion (for example, the first transport block 805-h may be an SPS PDSCH transmission), and the UE may successfully decode the transport block 805-h. Accordingly, the UE may transmit the HARQ ACK 845-c to indicate the successful decoding of the transport block 805-h.

Then, the network node may transmit the DCI 815-g scheduling the transport block 805-i, but the UE may miss the transmission of the DCI 815-g and the transport block 805-i (for example, the UE may not detect or decode the DCI 815-g or the transport block 805-i). The transport block 805-i may be associated with a same HARQ identifier ‘x’ as the previous transport block 805-h, and may be associated with a C-RNTI. In response to failing to detect or decode the DCI 815-g, the UE may indicate a HARQ NACK 835-d to the network node.

However, due to a NACK to ACK error, the network node may unsuccessfully terminate the HARQ process associated with the transport block 805-i and may transmit another transport block 805-j associated with the same HARQ identifier ‘x,’ which may be an SPS PDSCH transmitted via an SPS occasion. Then, the network node may additionally transmit the DCI 815-h scheduling another transport block 805 (such as an initial transmission of the transport block 805) associated with the same HARQ identifier ‘x.’

The UE may identify the unsuccessful termination of the HARQ process associated with the transport block 805-i in response to the expected value of the NDI indicated by the DCI 815-h being different from the NDI of 3 indicated by the DCI 815-h. The UE may increment the expected NDI value (such as from an NDI value of 3 indicated by a DCI received prior to the transport block 805-h) in response to receiving the transport block 805-h (since the transport block 805-h is associated with the same HARQ identifier and includes an initial SPS PDSCH). Additionally, because the UE does not detect the DCI 815-g or the transport block 805-i, the UE may not increment the expected NDI value in response to the network node transmitting the DCI 815-g. The UE may increment the expected NDI value in response to receiving the transport block 805-j (since the transport block 805-j is associated with the same HARQ identifier and includes an initial SPS PDSCH). Therefore, the UE may expect that the NDI field in the DCI 815-h indicates a value of 2. However, because the NDI field in the DCI 815-h indicates a value of 3, the UE may identify that there is 1 missing NDI (corresponding to a single unsuccessfully terminated HARQ process). Here, the UE may transmit the unsuccessful HARQ process termination indication 840-c in response to identifying the unsuccessfully terminated HARQ process.

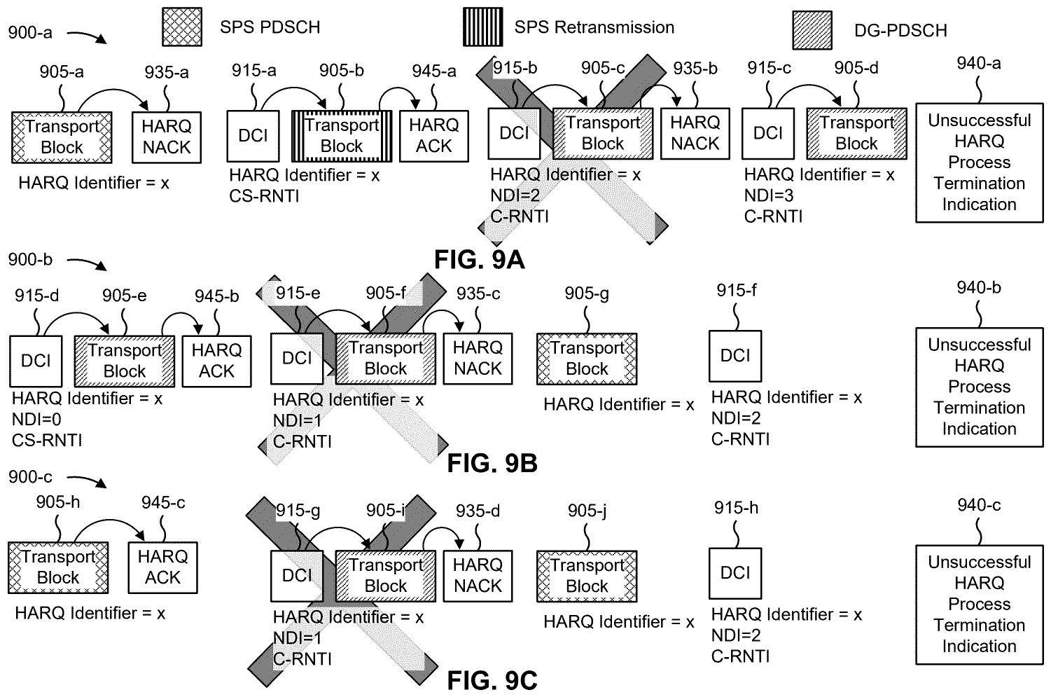

FIGS. 9A through 9C are diagrams illustrating examples 900 of signaling exchanged between a transmitting and receiving device (for example, between a network node and a UE) in accordance with the present disclosure.

In the examples 900, a UE may fail to detect or decode a DCI 915 that schedules a new or initial transmission of a transport block (such as the DCI 915-b scheduling the transport block 905-c, the DCI 915-e scheduling the transport block 905-f, and the DCI 915-g scheduling the transport block 905-i). In response to failing to detect or decode the DCI 915, the UE may indicate a HARQ NACK 935 to the network node. In some cases, the UE may indicate the HARQ NACK 935 by transmitting a HARQ NACK 935. Additionally or alternatively, the UE may indicate the HARQ NACK 935 may refraining from transmitting any HARQ feedback. In either case, the network node may incorrectly interpret the HARQ NACKs 935 (such as the HARQ NACKs 935-b, 935-c, and 935-d) as a HARQ ACK, which may result in an unsuccessful termination of a HARQ process associated with the transport blocks 905-c, 905-f, and 905-i.

In the example 900, the NDIs may be incremented by 1 in response to C-RNTIs, and the NDIs may not be incremented by 1 in response to an SPS PDSCH transmissions or CS-RNTIs. That is, the NDIs may be incremented by 1 irrespective of SPS PDSCH occasions or CS-RNTIs. Accordingly, the network node may increment an NDI for transport block 905 transmissions that are associated with C-RNTIs (and may not increment the NDI associated with the HARQ identifier for any transmissions that are associated with CS-RNTIs). Accordingly, a UE may determine if there are any missing NDIs (such as NDIs associated with SPS PDSCH transmissions and/or NDIs associated with non-SPS transmissions) in response to a gap between an expected NDI value and an NDI value indicated by a DCI 915.

In the example 900, the UE may determine if there are one or more unsuccessful HARQ process terminations for a given HARQ identifier (such as for HARQ identifier ‘x’) by comparing an expected value of the NDI (which is based on or otherwise associated with a quantity of transmissions associated with C-RNTIs) to a value of the NDI indicated by a DCI scrambled by C-RNTI. That is, the UE May increment the expected value of the NDI in response to receiving a transport block 905 associated with a C-RNTI, and may refrain from incremented the expected value of the NDI in response to receiving any transport blocks 905 associated with a CS-RNTI. The UE may additionally perform a modulo operation to identify the expected value carried in an NDI field of the DCI 915. In the example 900, the UE may perform a modulo 4 operation.

In the examples 900, the UE may identify the unsuccessful terminations of the HARQ processes associated with the transport blocks 905-c, 905-f, and 905-i based on or otherwise associated with a difference between the expected value of the NDI and the value of the NDI indicated by an NDI field in the dci 915. Then, the UE may report the unsuccessful terminations of the HARQ processes via the unsuccessful HARQ process termination indications 940-a, 940-b, and 940-c. In some cases, the UE may indicate, within the unsuccessful HARQ process termination indication 940, that the expected value of the NDI is different from the value of the NDI indicated by the DCI 915.

In the examples 900, HARQ identifiers may be shared between C-RNTI and CS-RNTIs. That is, the network node may indicate, to the UE (such as via RRC configuration) HARQ identifiers may be shared between C-RNTI and CS-RNTIs. In instances where the network node indicates that HARQ identifiers may not be shared between C-RNTI and CS-RNTIs, the UE may not identify the unsuccessful termination of the HARQ processes in accordance with the examples 900.

In the example 900-a, the network node may transmit a first transport block 905-a via an SPS occasion (for example, the first transport block 905-a may be an SPS PDSCH transmission), and the UE may fail to successfully decode the transport block 905-a. Accordingly, the UE may transmit the HARQ NACK 935-a to indicate the failure of the UE to successfully decode the transport block 905-a. As part of a HARQ process for the transport block 905-a, the network node may schedule a retransmission of the transport block 905-a via the DCI 915-a, which may schedule the transport block 905-b (which may include the SPS retransmission associated with the transport block 905-a). The UE may successfully receive and decode the transport block 905-b, and may therefore transmit the HARQ ACK 945-a indicating that the UE successfully decodes the transport block 905-b.

Then, the network node may transmit the DCI 915-b scheduling the transport block 905-c, but the UE may miss the transmission of the DCI 915-b and the transport block 905-c (for example, the UE may not detect or decode the DCI 915-b or the transport block 905-c). The transport block 905-c may be associated with a same HARQ identifier ‘x’ as the previous transport blocks 905-a and 905-b, and may be associated with a C-RNTI. In response to failing to detect or decode the DCI 915-b, the UE may indicate a HARQ NACK 935-b to the network node.

However, due to a NACK to ACK error, the network node may unsuccessfully terminate the HARQ process associated with the transport block 905-c and may transmit another DCI 915-c scheduling another transport block 905-d (such as an initial transmission of the transport block 905-d) associated with the same HARQ identifier

The UE may identify the unsuccessful termination of the HARQ process associated with the transport block 905-c in response to the expected value of the NDI indicated by the DCI 915-c being different from the NDI of 3 indicated by the DCI 915-c. For example, a previously NDI for a C-RNTI associated with the HARQ identifier ‘x’ (such as an NDI indicated by a DCI received prior to a reception of the transport block 905-a) may indicate an NDI of ‘1.’ The UE may refrain from incrementing the expected NDI value in response to receiving the transport block 905-a (since the transport block 905-a is associated with an SPS PDSCH and a CS-RNTI rather than a C-RNTI) and may refrain from incrementing the expected NDI value in response to receiving the transport block 905-b (since the transport block 905-b is not associated with a C-RNTI). Additionally, because the UE does not detect the DCI 915-b or the transport block 905-c, the UE may not increment the expected NDI value in response to the network node transmitting the DCI 915-b. Therefore, the UE may expect that the NDI field in the DCI 915-c indicates a value of 2. However, because the NDI field in the DCI 915-c indicates a value of 3, the UE may identify that there is 1 missing NDI (corresponding to a single unsuccessfully terminated HARQ process). Here, the UE may transmit the unsuccessful HARQ process termination indication 940-a in response to identifying the unsuccessfully terminated HARQ process.

In the example 900-b, the network node may transmit DCI 915-d with scheduling information for a first transport block 905-e. The DCI 915-d may additionally indicate that the transport block 905-e is associated with the HARQ identifier of ‘x’ and that the transport block 905-e is associated with a C-RNTI. The UE may be successfully decode the transport block 905-e, and may transmit the HARQ ACK 945-b to indicate, to the network node, the successful decoding of the transport block 905-e.

Then, the network node may transmit the DCI 915-e scheduling the transport block 905-f, but the UE may miss the transmission of the DCI 915-e and the transport block 905-f (for example, the UE may not detect or decode the DCI 915-e or the transport block 905-f). The transport block 905-f may be associated with a same HARQ identifier ‘x’ as the previous transport block 905-e, and may be associated with a C-RNTI. In response to failing to detect or decode the DCI 915-e, the UE may indicate a HARQ NACK 935-c to the network node.

However, due to a NACK to ACK error, the network node may unsuccessfully terminate the HARQ process associated with the transport block 905-c and may transmit another transport block 905-g associated with the same HARQ identifier ‘x,’ which may be an SPS PDSCH transmitted via an SPS occasion. Then, the network node may additionally transmit the DCI 915-f scheduling another transport block 905 (such as an initial transmission of the transport block 905) associated with the same HARQ identifier ‘x.’

The UE may identify the unsuccessful termination of the HARQ process associated with the transport block 905-f in response to the expected value of the NDI indicated by the DCI 915-f being different from the NDI of 2 indicated by the DCI 915-f. The UE may refrain from incrementing the expected NDI value (such as from the NDI value of 0 indicated by the DCI 915-d) in response to receiving the transport block 905-g (since the transport block 905-g is associated with an SPS PDSCH and a CS-RNTI and not a C-RNTI). Additionally, because the UE does not detect the DCI 915-e or the transport block 905-f, the UE may not increment the expected NDI value in response to the network node transmitting the DCI 915-e. Therefore, the UE may expect that the NDI field in the DCI 915-f indicates a value of 1. However, because the NDI field in the DCI 915-f indicates a value of 2, the UE may identify that there is 1 missing NDI (corresponding to a single unsuccessfully terminated HARQ process). Here, the UE may transmit the unsuccessful HARQ process termination indication 940-b in response to identifying the unsuccessfully terminated HARQ process.

In the example 900-c, the network node may transmit a first transport block 905-h via an SPS occasion (for example, the first transport block 905-h may be an SPS PDSCH transmission), and the UE may successfully decode the transport block 905-h. Accordingly, the UE may transmit the HARQ ACK 945-c to indicate the successful decoding of the transport block 905-h.

Then, the network node may transmit the DCI 915-g scheduling the transport block 905-i, but the UE may miss the transmission of the DCI 915-g and the transport block 905-i (for example, the UE may not detect or decode the DCI 915-g or the transport block 905-i). The transport block 905-i may be associated with a same HARQ identifier ‘x’ as the previous transport block 905-h, and may be associated with a C-RNTI. In response to failing to detect or decode the DCI 915-g, the UE may indicate a HARQ NACK 935-d to the network node.

However, due to a NACK to ACK error, the network node may unsuccessfully terminate the HARQ process associated with the transport block 905-i and may transmit another transport block 905-j associated with the same HARQ identifier ‘x,’ which may be an SPS PDSCH transmitted via an SPS occasion. Then, the network node may additionally transmit the DCI 915-h scheduling another transport block 905 (such as an initial transmission of the transport block 905) associated with the same HARQ identifier ‘x’.

The UE may identify the unsuccessful termination of the HARQ process associated with the transport block 905-i in response to the expected value of the NDI indicated by the DCI 915-h being different from the NDI of 3 indicated by the DCI 915-h. The UE may refrain from incrementing the expected NDI value from an NDI value of 0 indicated by a DCI received prior to the transport block 905-h (since the transport block 905-h is associated with an SPS PDSCH and CS-RNTI, and not associated with a C-RNTI). Additionally, because the UE does not detect the DCI 915-g or the transport block 905-i, the UE may not increment the expected NDI value in response to the network node transmitting the DCI 915-g. The UE may also not increment the expected NDI value in response to receiving the transport block 905-j (since the transport block 905-j is an SPS PDSCH and a CS-RNTI rather than being associated with a C-RNTI). Therefore, the UE may expect that the NDI field in the DCI 915-h indicates a value of 1. However, because the NDI field in the DCI 915-h indicates a value of 2, the UE may identify that there is 1 missing NDI (corresponding to a single unsuccessfully terminated HARQ process). Here, the UE may transmit the unsuccessful HARQ process termination indication 940-c in response to identifying the unsuccessfully terminated HARQ process.

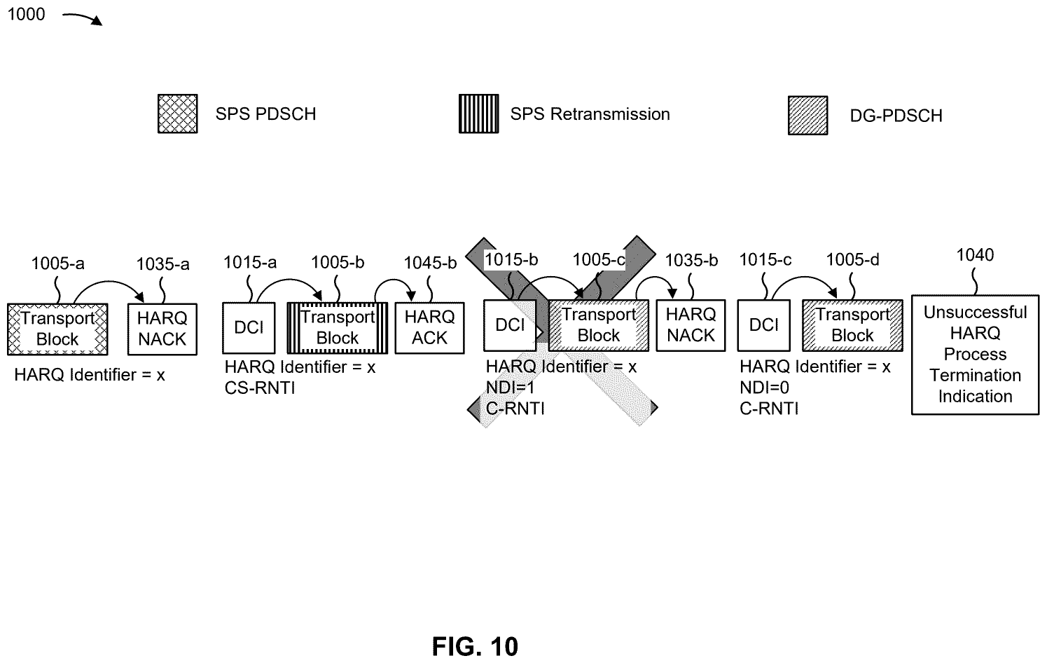

FIG. 10 is a diagram illustrating an example 1000 of signaling exchanged between a transmitting and receiving device (for example, between a network node and a UE) in accordance with the present disclosure.

In the example 1000, the network node may transmit a first transport block 1005-a via an SPS occasion (for example, the first transport block 1005-a may be an SPS PDSCH transmission), and the UE may fail to successfully decode the transport block 1005-a. Accordingly, the UE may transmit the HARQ NACK 1035-a to indicate the failure of the UE to successfully decode the transport block 1005-a. As part of a HARQ process for the transport block 1005-a, the network node may schedule a retransmission of the transport block 1005-a via the DCI 1015-a, which may schedule the transport block 1005-b (which may include the SPS retransmission associated with the transport block 1005-a). The UE may successfully receive and decode the transport block 1005-b, and may therefore transmit the HARQ ACK 1045-b indicating that the UE successfully decodes the transport block 1005-b.

Then, the network node may transmit the DCI 1015-b scheduling the transport block 1005-c, but the UE may miss the transmission of the DCI 1015-b and the transport block 1005-c (for example, the UE may not detect or decode the DCI 1015-b or the transport block 1005-c). The transport block 1005-c may be associated with a same HARQ identifier ‘x’ as the previous transport blocks 1005-a and 1005-b, and may be associated with a C-RNTI. In response to failing to detect or decode the DCI 1015-b, the UE may indicate a HARQ NACK 1035-b to the network node. In some cases, the UE may indicate the HARQ NACK 1035-b by transmitting a HARQ NACK 1035-b. Additionally or alternatively, the UE may indicate the HARQ NACK 1035-b may refraining from transmitting any HARQ feedback. In either case, the network node may incorrectly interpret the HARQ NACK 1035-b as a HARQ ACK, which may result in an unsuccessful termination of a HARQ process associated with the transport block 1005-c.

In some cases (such as due to the NACK to ACK error) the network node may transmit another DCI 1015-c scheduling another transport block 1005-d (such as an initial transmission of the transport block 1005-d) associated with the same HARQ identifier ‘x.’

In the example 1000, the UE may identify the unsuccessful termination of the HARQ process associated with the transport block 1000-c in response to a difference between an expected NDI value and the value of the NDI indicated by the NDI field in the DCI 1015-c. In particular, the UE may assume a fixed or predetermined NDI value for a first transport block 1005 associated with a C-RNTI that is scheduled after an SPS PDSCH transmission having the same HARQ identifier (such as the HARQ identifier ‘x’). In some cases, the network node may indicate, to the UE, a value associated with the fixed or predetermined NDI value (such as a value of ‘0’ or ‘1’). In cases where the NDI value indicated by the NDI field in a first DCI 1015 having a CRC scrambled with a C-RNTI after a previous SPS PDSCH transmission or SPS retransmission for the same HARQ identifier (such as the DCI 1015-c) is the same as the predetermined or fixed NDI value, the UE may not identify an unsuccessful termination of a HARQ process. Additionally, in cases where the NDI value indicated by the NDI field in a first DCI 1015 having a CRC scrambled with a C-RNTI after a previous SPS PDSCH transmission or SPS retransmission for the same HARQ identifier (such as the DCI 1015-c) is different from the predetermined or fixed NDI value, the UE may identify an unsuccessful termination of a HARQ process.

In the example 1000, the NDI value indicated by the NDI field in the first DCI 1015 having a CRC scrambled with a C-RNTI after a previous SPS PDSCH transmission or SPS retransmission may be predetermined or fixed to be ‘1.’ Because the DCI 1015-c includes an NDI field indicating an NDI value of 0 (which is not the predetermined or fixed value expected by the UE in the DCI 1015), the UE may identify and report the unsuccessful termination of the HARQ process associated with the transport block 1005-c. That is, the UE may transmit, to the network node, the unsuccessful HARQ process termination indication 1040.

In the examples 1000, HARQ identifiers may be shared between C-RNTI and CS-RNTIs. That is, the network node may indicate, to the UE (such as via RRC configuration) HARQ identifiers may be shared between C-RNTI and CS-RNTIs. In instances where the network node indicates that HARQ identifiers may not be shared between C-RNTI and CS-RNTIs, the UE may not identify the unsuccessful termination of the HARQ processes in accordance with the examples 1000.

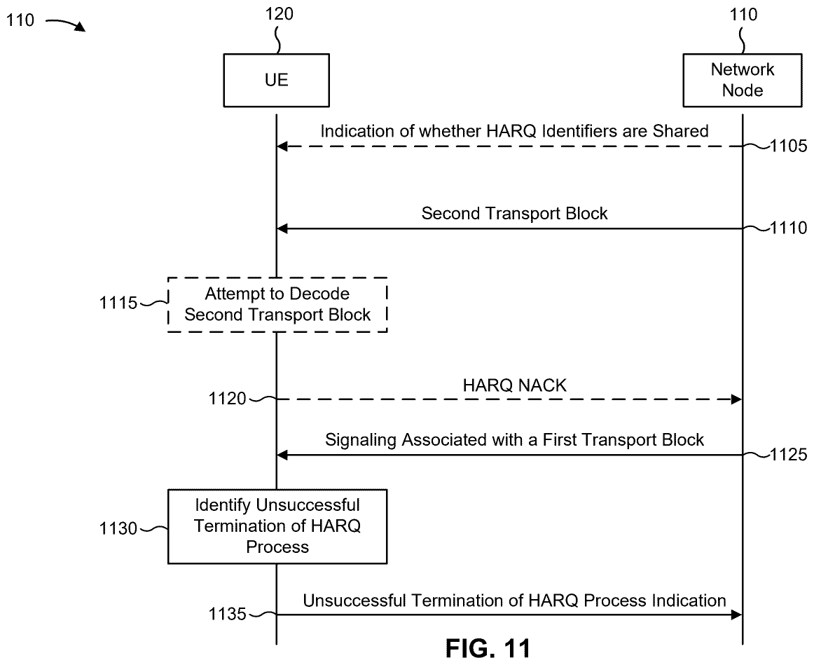

FIG. 11 is a diagram illustrating an example 1100 of signaling exchanged between a network node 110 and a UE 120, in accordance with the present disclosure. In some cases, the network node 110 and the UE 120 may implement aspects of other examples described herein.

In a first operation 1105, the network node 110 may optionally transmit, and the UE 120 may receive, an indication of whether HARQ identifiers are shared between transport blocks associated with C-RNTIs and transport blocks associated with CS-RNTIs. In some cases, the network node 110 may indicate whether the HARQ identifiers are shared explicitly (such as via RRC signaling). The network node 110 may indicate whether HARQ identifiers are shared between C-RNTI and CS-RNTIs per component carrier (for example, some component carriers may be configured with shared HARQ identifiers while other component carriers may be configured without shared HARQ identifiers), per HARQ identifier (for example, some HARQ identifiers may be shared, while other HARQ identifiers may not be shared), or per SPS configuration (such as for the HARQ identifiers configured for each SPS configuration).

In a second operation 1110, the network node 110 may transmit, and the UE 120 may attempt to receive, a second transport block.

In a third operation 1115, the UE 120 may optionally attempt to decode the second transport block. In particular, if the UE 120 detects the transmission of the second transport block, the UE 120 may attempt to decode the second transport block. In some other cases, the UE 120 may fail to receive control information scheduling the transmission of the second transport block. Here, the UE 120 may not be aware that the network node 110 transmits the second transport block at 1115, and may therefore not attempt to decode the second transport block.

In a fourth operation 1120, the UE 120 may optionally transmit a HARQ NACK to the network node 110 indicating a failure of the UE 120 to decode the second transport block. For example, in cases where the UE 120 attempted to decode the second transport block at 1115, the UE 120 may fail to decode the second transport block, and may transmit the HARQ NACK to the network node 110 at 1120. In other cases where the UE 120 did not attempt to decode the second transport block at 1115, the UE 120 may not transmit the HARQ NACK to the network node 110.

In a fifth operation 1125, the network Node 110 may transmit, and the UE may receive, signaling associated with a first transport block. The signaling associated with the first transport block may indicate that the first transport block has a same HARQ identifier as the second transport block. Additionally, at least one of the first transport block and the second transport block may be associated with SPS. For example, the first transport block or the second transport block may be associated with a CS-RNTI, be transmitted via an SPS occasion, and/or correspond to an SPS retransmission. In a sixth operation 1130, the UE 120 may identify an unsuccessful

termination of a HARQ process associated with the second transport block in response to a failure of the UE 120 to successfully decode the second transport block, the first transport block having the same HARQ identifier as the second transport block, or an NDI (for example, a value indicated by an NDI field) associated with the same HARQ identifier.

In a seventh operation 1135, the UE 120 may transmit, and the network node 110 may receive, signaling indicating the unsuccessful termination of the HARQ process.

FIG. 12 is a flowchart illustrating an example process 1200 performed, for example, at a UE or an apparatus of a UE that supports wireless communication in accordance with the present disclosure. Example process 1200 is an example where the apparatus or the UE (for example, UE 120) performs operations associated with an unsuccessful termination of a HARQ process associated with an SPS transmission.

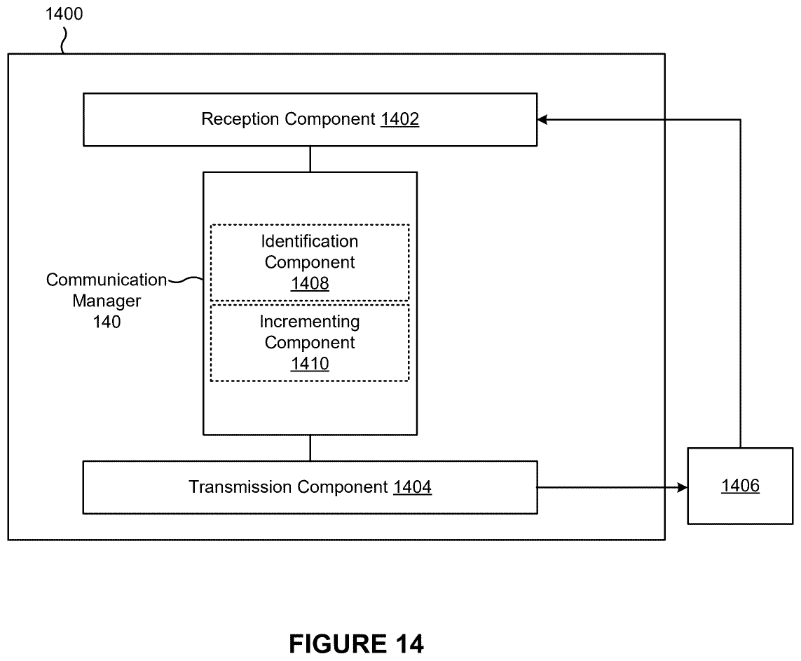

As shown in FIG. 12, in some aspects, process 1200 may include receiving, from a network node, first signaling associated with a first transport block, the first signaling indicating that the first transport block has a same HARQ identifier as a second transport block, wherein at least one of the first transport block and the second transport block are associated with SPS (block 1210). For example, the UE (such as by using communication manager 140 or reception component 1402, depicted in FIG. 14) may receive, from a network node, first signaling associated with a first transport block, the first signaling indicating that the first transport block has a same HARQ identifier as a second transport block, wherein at least one of the first transport block and the second transport block are associated with SPS, as described above.

As further shown in FIG. 12, in some aspects, process 1200 may include identifying an unsuccessful termination of a HARQ process associated with the second transport block in response to a failure of the UE to successfully decode the second transport block, the first transport block having the same HARQ identifier as the second transport block, or an NDI associated with the same HARQ identifier (block 1220). For example, the UE (such as by using communication manager 140 or identification component 1408, depicted in FIG. 14) may identify an unsuccessful termination of a HARQ process associated with the second transport block in response to a failure of the UE to successfully decode the second transport block, the first transport block having the same HARQ identifier as the second transport block, or an NDI associated with the same HARQ identifier, as described above.

As further shown in FIG. 12, in some aspects, process 1200 may include transmitting, to the network node, second signaling indicating the unsuccessful termination of the HARQ process associated with the second transport block (block 1230). For example, the UE (such as by using communication manager 140 or transmission component 1404, depicted in FIG. 14) may transmit, to the network node, second signaling indicating the unsuccessful termination of the HARQ process associated with the second transport block, as described above.

Process 1200 may include additional aspects, such as any single aspect or any combination of aspects described below or in connection with one or more other processes described elsewhere herein.

In a first additional aspect, process 1200 includes transmitting, to the network node prior to receiving the first signaling, a HARQ NACK associated with the second transport block, and identifying that the first transport block has the same HARQ identifier after transmitting the HARQ NACK and receiving the first signaling, wherein identifying the unsuccessful termination of the HARQ process is in response to the failure of the UE to successfully decode the second transport block and the first transport block having the same HARQ identifier as the second transport block.

In a second additional aspect, alone or in combination with the first aspect, the second transport block is associated with a CS-RNTI, the second signaling comprises the same HARQ identifier, and the second signaling indicates that the unsuccessful termination of the HARQ process is associated with the second transport block by including an indication that the unsuccessful termination of the HARQ process is associated with the CS-RNTI.

In a third additional aspect, alone or in combination with one or more of the first and second aspects, the second transport block is associated with a CS-RNTI, and the second signaling comprises an NDI field associated with the NDI associated with the same HARQ identifier, wherein the NDI field is set to a first value indicating that the unsuccessful termination of the HARQ process is associated with a transport block received via an SPS occasion, or a second value indicating that the unsuccessful termination of the HARQ process is associated with a transport block that comprises a retransmission of an SPS transmission.

In a fourth additional aspect, alone or in combination with one or more of the first through third aspects, process 1200 includes incrementing a value of the NDI in response to receiving, via an SPS occasion, any transport block associated with the same HARQ identifier, wherein the second signaling comprises an NDI field set to the value.

In a fifth additional aspect, alone or in combination with one or more of the first through fourth aspects, process 1200 includes receiving, from the network node and after receiving the first signaling, control signaling comprising scheduling information for a third transport block, an indication that the third transport block is associated with the same HARQ identifier as the first transport block and the second transport block, and the NDI associated with the same HARQ identifier having a first value, and transmitting, to the network node, third signaling indicating that an expected value of the NDI is different from the first value of the NDI.

In a sixth additional aspect, alone or in combination with one or more of the first through fifth aspects, process 1200 includes incrementing the expected value of the NDI in response to receiving, via SPS occasions, transport blocks that are associated with the same HARQ identifier and that are associated with CS-RNTIs, and receiving, via DG-PDSCH transmissions, transport blocks that are associated with the same HARQ identifier and that are associated with C-RNTIs, wherein transmitting the third signaling is in response to incrementing the expected value of the NDI.

In a seventh additional aspect, alone or in combination with one or more of the first through sixth aspects, process 1200 includes incrementing the expected value of the NDI in response to receiving, via DG-PDSCH transmissions, transport blocks that are associated with the same HARQ identifier and that are associated with C-RNTIs, and refraining from incrementing the expected value of the NDI in response to receiving transport blocks that are associated with the same HARQ identifier and that are associated with CS-RNTIs.

In an eighth additional aspect, alone or in combination with one or more of the first through seventh aspects, process 1200 includes identifying the expected value of the NDI in response to the third transport block being an initial transport block associated with the same HARQ identifier received after a reception of another transport block associated with the same HARQ identifier and associated with a CS-RNTI.

In a ninth additional aspect, alone or in combination with one or more of the first through eighth aspects, receiving the first signaling associated with the first transport block comprises receiving the first transport block via an SPS occasion.

In a tenth additional aspect, alone or in combination with one or more of the first through ninth aspects, process 1200 includes receiving, from the network node, the second transport block via a DG-PDSCH transmission.

In an eleventh additional aspect, alone or in combination with one or more of the first through tenth aspects, process 1200 includes receiving the second transport block via a second SPS occasion.

In a twelfth additional aspect, alone or in combination with one or more of the first through eleventh aspects, process 1200 includes receiving, from the network node, the second transport block, wherein the second transport block is associated with a CS-RNTI, and wherein the first signaling comprises control information scheduling the second transport block having a C-RNTI that indicates that the first transport block has the same HARQ identifier as the second transport block.

In a thirteenth additional aspect, alone or in combination with one or more of the first through twelfth aspects, receiving the second transport block comprises receiving the second transport block via an SPS occasion.

In a fourteenth additional aspect, alone or in combination with one or more of the first through thirteenth aspects, receiving the second transport block comprises receiving a retransmission of an SPS transmission of the second transport block.

In a fifteenth additional aspect, alone or in combination with one or more of the first through fourteenth aspects, process 1200 includes receiving, from the network node, control signaling indicating that HARQ identifiers may be shared between transport blocks associated with CS-RNTIs and transport blocks associated with C-RNTIs, wherein transmitting the second signaling is in response to receiving the control signaling.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a flowchart illustrating an example process 1300 performed, for example, at a network node or an apparatus of a network node that supports wireless communication in accordance with the present disclosure. Example process 1300 is an example where the apparatus or the network node (for example, network node 110) performs operations associated with an unsuccessful termination of a HARQ process associated with an SPS transmission.

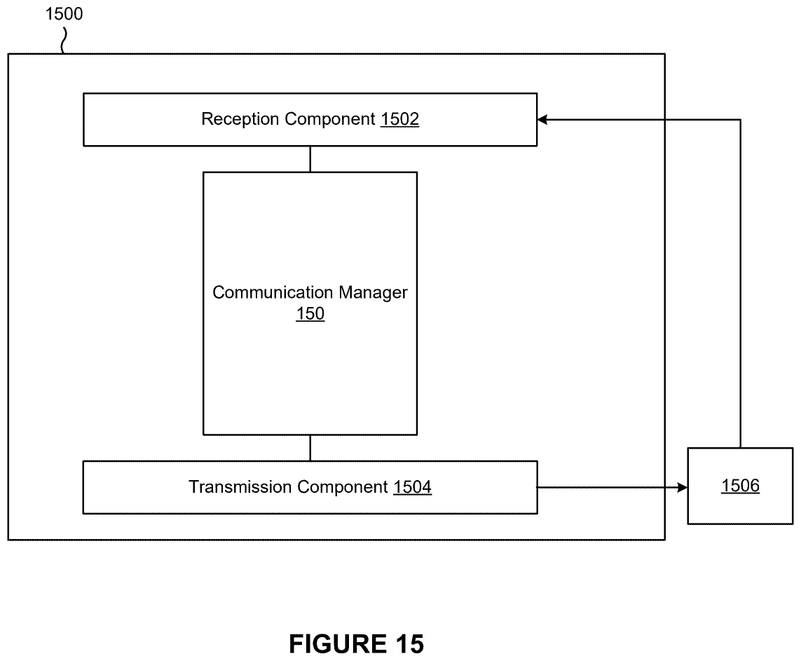

As shown in FIG. 13, in some aspects, process 1300 may include transmitting, to a UE, first signaling associated with a first transport block, the first signaling indicating that the first transport block has a same HARQ identifier as a second transport block, wherein at least one of the first transport block and the second transport block are associated with SPS (block 1310). For example, the network node (such as by using communication manager 150 or transmission component 1504, depicted in FIG. 15) may transmit, to a UE, first signaling associated with a first transport block, the first signaling indicating that the first transport block has a same HARQ identifier as a second transport block, wherein at least one of the first transport block and the second transport block are associated with SPS, as described above.

As further shown in FIG. 13, in some aspects, process 1300 may include receiving, from the UE, second signaling indicating an unsuccessful termination of a HARQ process associated with the second transport block in response to a failure of the UE to successfully decode the second transport block, the first transport block having the same HARQ identifier as the second transport block, or an NDI associated with the same HARQ identifier (block 1320). For example, the network node (such as by using communication manager 150 or reception component 1502, depicted in FIG. 15) may receive, from the UE, second signaling indicating an unsuccessful termination of a

HARQ process associated with the second transport block in response to a failure of the UE to successfully decode the second transport block, the first transport block having the same HARQ identifier as the second transport block, or an NDI associated with the same HARQ identifier, as described above.

Process 1300 may include additional aspects, such as any single aspect or any combination of aspects described below or in connection with one or more other processes described elsewhere herein.

In a first additional aspect, process 1300 includes receiving, from the UE prior to receiving the first signaling, a HARQ NACK associated with the second transport block, wherein receiving the second signaling is in response to the failure of the UE to successfully decode the second transport block and the first transport block having the same HARQ identifier as the second transport block.

In a second additional aspect, alone or in combination with the first aspect, the second transport block is associated with a CS-RNTI, the second signaling comprises the same HARQ identifier, and the second signaling indicates that the unsuccessful termination of the HARQ process is associated with the second transport block by including an indication that the unsuccessful termination of the HARQ process is associated with the CS-RNTI.

In a third additional aspect, alone or in combination with one or more of the first and second aspects, the second transport block is associated with a CS-RNTI, and the second signaling comprises an NDI field associated with the NDI associated with the same HARQ identifier, wherein the NDI field is set to a first value indicating that the unsuccessful termination of the HARQ process is associated with a transport block received via an SPS occasion, or a second value indicating that the unsuccessful termination of the HARQ process is associated with a transport block that comprises a retransmission of an SPS transmission.

In a fourth additional aspect, alone or in combination with one or more of the first through third aspects, process 1300 includes transmitting, to the UE and after transmitting the first signaling, control signaling comprising scheduling information for a third transport block, an indication that the third transport block is associated with the same HARQ identifier as the first transport block and the second transport block, and the NDI associated with the same HARQ identifier having a first value, and receiving, from the UE, third signaling indicating that an expected value of the NDI is different from the first value of the NDI.

In a fifth additional aspect, alone or in combination with one or more of the first through fourth aspects, the expected value of the NDI is based at least in part on a first quantity of transport blocks that are associated with the same HARQ identifier, that are associated with CS-RNTIs, and that are transmitted by the network node via SPS occasions, or a second quantity of transport blocks that are associated with the same HARQ identifier, that are associated with C-RNTIs, and that are transmitted by the network node via DG-PDSCH transmissions.

In a sixth additional aspect, alone or in combination with one or more of the first through fifth aspects, the expected value of the NDI is based at least in part on the third transport block being an initial transport block associated with the same HARQ identifier transmitted after a reception of another transport block associated with the same HARQ identifier and associated with a CS-RNTI.

In a seventh additional aspect, alone or in combination with one or more of the first through sixth aspects, transmitting the first signaling associated with the first transport block comprises transmitting the first transport block via an SPS occasion.

In an eighth additional aspect, alone or in combination with one or more of the first through seventh aspects, process 1300 includes transmitting, to the UE, the second transport block via a DG-PDSCH transmission.

In a ninth additional aspect, alone or in combination with one or more of the first through eighth aspects, process 1300 includes transmitting the second transport block via a second SPS occasion.

In a tenth additional aspect, alone or in combination with one or more of the first through ninth aspects, process 1300 includes transmitting the second transport block to the UE, wherein the second transport block is associated with a CS-RNTI, and wherein the first signaling comprises control information scheduling the second transport block having a C-RNTI that indicates that the first transport block has the same HARQ identifier as the second transport block.

In an eleventh additional aspect, alone or in combination with one or more of the first through tenth aspects, transmitting the second transport block comprises transmitting the second transport block via an SPS occasion.

In a twelfth additional aspect, alone or in combination with one or more of the first through eleventh aspects, transmitting the second transport block comprises transmitting a retransmission of an SPS transmission of the second transport block.

In a thirteenth additional aspect, alone or in combination with one or more of the first through twelfth aspects, process 1300 includes transmitting, to the UE, control signaling indicating that HARQ identifiers may be shared between transport blocks associated with CS-RNTIs and transport blocks associated with C-RNTIs, wherein receiving the second signaling is in response to transmitting the control signaling.

Although FIG. 13 shows example blocks of process 1300, in some aspects, process 1300 may include additional blocks, fewer blocks, different blocks, or differently arranged blocks than those depicted in FIG. 13. Additionally or alternatively, two or more of the blocks of process 1300 may be performed in parallel.

FIG. 14 is a diagram of an example apparatus 1400 for wireless communication that supports an unsuccessful termination of a HARQ process associated with an SPS transmission in accordance with the present disclosure. The apparatus 1400 may be a UE, or a UE may include the apparatus 1400. In some aspects, the apparatus 1400 includes a reception component 1402, a transmission component 1404, and a communication manager 140, which may be in communication with one another (for example, via one or more buses). As shown, the apparatus 1400 may communicate with another apparatus 1406 (such as a UE, a network node, or another wireless communication device) using the reception component 1402 and the transmission component 1404.

In some aspects, the apparatus 1400 may be configured to and/or operable to perform one or more operations described herein in connection with FIGS. 4-11. Additionally or alternatively, the apparatus 1400 may be configured to and/or operable to perform one or more processes described herein, such as process 1200 of FIG. 12. In some aspects, the apparatus 1400 may include one or more components of the UE described above in connection with FIG. 2.

The reception component 1402 may receive communications, such as reference signals, control information, and/or data communications, from the apparatus 1406. The reception component 1402 may provide received communications to one or more other components of the apparatus 1400, such as the communication manager 140. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1402 may include one or more antennas, one or more modems, one or more demodulators, one or more MIMO detectors, one or more receive processors, one or more controllers/processors, and/or one or more memories of the UE described above in connection with FIG. 2.

The transmission component 1404 may transmit communications, such as reference signals, control information, and/or data communications, to the apparatus 1406. In some aspects, the communication manager 140 may generate communications and may transmit the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, one or more modems, one or more modulators, one or more transmit MIMO processors, one or more transmit processors, one or more controllers/processors, and/or one or more memories of the UE described above in connection with FIG. 2. In some aspects, the transmission component 1404 may be co-located with the reception component 1402 in one or more transceivers.

The communication manager 140 may receive or may cause the reception component 1402 to receive, from a network node, first signaling associated with a first transport block, the first signaling indicating that the first transport block has a same HARQ identifier as a second transport block, wherein at least one of the first transport block and the second transport block are associated with SPS. The communication manager 140 may identify an unsuccessful termination of a HARQ process associated with the second transport block in response to a failure of the UE to successfully decode the second transport block, the first transport block having the same HARQ identifier as the second transport block, or an NDI associated with the same HARQ identifier. The communication manager 140 may transmit or may cause the transmission component 1404 to transmit, to the network node, second signaling indicating the unsuccessful termination of the HARQ process associated with the second transport block. In some aspects, the communication manager 140 may perform one or more operations described elsewhere herein as being performed by one or more components of the communication manager 140.

The communication manager 140 may include one or more controllers/processors, and/or one or more memories of the UE described above in connection with FIG. 2. In some aspects, the communication manager 140 includes a set of components, such as an identification component 1408, and/or an incrementing component 1410. Alternatively, the set of components may be separate and distinct from the communication manager 140. In some aspects, one or more components of the set of components may include or may be implemented within one or more controllers/processors and/or one or more memories of the UE described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive, from a network node, first signaling associated with a first transport block, the first signaling indicating that the first transport block has a same HARQ identifier as a second transport block, wherein at least one of the first transport block and the second transport block are associated with SPS. The identification component 1408 may identify an unsuccessful termination of a HARQ process associated with the second transport block in response to a failure of the UE to successfully decode the second transport block, the first transport block having the same HARQ identifier as the second transport block, or an NDI associated with the same HARQ identifier. The transmission component 1404 may transmit, to the network node, second signaling indicating the unsuccessful termination of the HARQ process associated with the second transport block.

The transmission component 1404 may transmit, to the network node prior to receiving the first signaling, a HARQ NACK associated with the second transport block.

The identification component 1408 may identify that the first transport block has the same HARQ identifier after transmitting the HARQ NACK and receiving the first signaling, wherein identifying the unsuccessful termination of the HARQ process is in response to the failure of the UE to successfully decode the second transport block and the first transport block having the same HARQ identifier as the second transport block.

The incrementing component 1410 may increment a value of the NDI in response to receiving, via an SPS occasion, any transport block associated with the same HARQ identifier, wherein the second signaling comprises an NDI field set to the value.

The reception component 1402 may receive, from the network node and after receiving the first signaling, control signaling comprising scheduling information for a third transport block, an indication that the third transport block is associated with the same HARQ identifier as the first transport block and the second transport block, and the NDI associated with the same HARQ identifier having a first value.

The transmission component 1404 may transmit, to the network node, third signaling indicating that an expected value of the NDI is different from the first value of the NDI.

The incrementing component 1410 may increment the expected value of the NDI in response receiving, via SPS occasions, transport blocks that are associated with the same HARQ identifier and that are associated with CS-RNTIs, and receiving, via DG-PDSCH transmissions, transport blocks that are associated with the same HARQ identifier and that are associated with C-RNTIs, wherein transmitting the third signaling is in response to incrementing the expected value of the NDI.

The incrementing component 1410 may increment the expected value of the NDI in response to receiving, via DG-PDSCH transmissions, transport blocks that are associated with the same HARQ identifier and that are associated with C-RNTIs.

The incrementing component 1410 may refrain from incrementing the expected value of the NDI in response to receiving transport blocks that are associated with the same HARQ identifier and that are associated with CS-RNTIs.

The identification component 1408 may identify the expected value of the NDI in response to the third transport block being an initial transport block associated with the same HARQ identifier received after a reception of another transport block associated with the same HARQ identifier and associated with a CS-RNTI.

The reception component 1402 may receive, from the network node, the second transport block via a DG-PDSCH transmission.

The reception component 1402 may receive the second transport block via a second SPS occasion.

The reception component 1402 may receive, from the network node, the second transport block, wherein the second transport block is associated with a CS-RNTI, and wherein the first signaling comprises control information scheduling the second transport block having a C-RNTI that indicates that the first transport block has the same HARQ identifier as the second transport block.

The reception component 1402 may receive, from the network node, control signaling indicating that HARQ identifiers may be shared between transport blocks associated with CS-RNTIs and transport blocks associated with C-RNTIs, wherein transmitting the second signaling is in response to receiving the control signaling.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

FIG. 15 is a diagram of an example apparatus 1500 for wireless communication that supports an unsuccessful termination of a HARQ process associated with an SPS transmission in accordance with the present disclosure. The apparatus 1500 may be a network node, or a network node may include the apparatus 1500. In some aspects, the apparatus 1500 includes a reception component 1502, a transmission component 1504, and a communication manager 150, which may be in communication with one another (for example, via one or more buses). As shown, the apparatus 1500 may communicate with another apparatus 1506 (such as a UE, a network node, or another wireless communication device) using the reception component 1502 and the transmission component 1504.

In some aspects, the apparatus 1500 may be configured to and/or operable to perform one or more operations described herein in connection with FIGS. 4-11. Additionally or alternatively, the apparatus 1500 may be configured to and/or operable to perform one or more processes described herein, such as process 1300 of FIG. 13. In some aspects, the apparatus 1500 may include one or more components of the network node described above in connection with FIG. 2.

The reception component 1502 may receive communications, such as reference signals, control information, and/or data communications, from the apparatus 1506. The reception component 1502 may provide received communications to one or more other components of the apparatus 1500, such as the communication manager 150. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1502 may include one or more antennas, one or more modems, one or more demodulators, one or more MIMO detectors, one or more receive processors, one or more controllers/processors, and/or one or more memories of the network node described above in connection with FIG. 2.

The transmission component 1504 may transmit communications, such as reference signals, control information, and/or data communications, to the apparatus 1506. In some aspects, the communication manager 150 may generate communications and may transmit the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, one or more modems, one or more modulators, one or more transmit MIMO processors, one or more transmit processors, one or more controllers/processors, and/or one or more memories of the network node described above in connection with FIG. 2. In some aspects, the transmission component 1504 may be co-located with the reception component 1502 in one or more transceivers.

The communication manager 150 may transmit or may cause the transmission component 1504 to transmit, to a UE, first signaling associated with a first transport block, the first signaling indicating that the first transport block has a same HARQ identifier as a second transport block, wherein at least one of the first transport block and the second transport block are associated with SPS. The communication manager 150 may receive or may cause the reception component 1502 to receive, from the UE, second signaling indicating an unsuccessful termination of a HARQ process associated with the second transport block in response to a failure of the UE to successfully decode the second transport block, the first transport block having the same HARQ identifier as the second transport block, or an NDI associated with the same HARQ identifier. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 2. In some aspects, the communication manager 150 includes a set of components. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 1504 may transmit, to a UE, first signaling associated with a first transport block, the first signaling indicating that the first transport block has a same HARQ identifier as a second transport block, wherein at least one of the first transport block and the second transport block are associated with SPS. The reception component 1502 may receive, from the UE, second signaling indicating an unsuccessful termination of a HARQ process associated with the second transport block in response to a failure of the UE to successfully decode the second transport block, the first transport block having the same HARQ identifier as the second transport block, or an NDI associated with the same HARQ identifier.

The reception component 1502 may receive, from the UE prior to receiving the first signaling, a HARQ NACK associated with the second transport block, wherein receiving the second signaling is in response to the failure of the UE to successfully decode the second transport block and the first transport block having the same HARQ identifier as the second transport block.

The transmission component 1504 may transmit, to the UE and after transmitting the first signaling, control signaling comprising scheduling information for a third transport block, an indication that the third transport block is associated with the same HARQ identifier as the first transport block and the second transport block, and the NDI associated with the same HARQ identifier having a first value.

The reception component 1502 may receive, from the UE, third signaling indicating that an expected value of the NDI is different from the first value of the NDI.

The transmission component 1504 may transmit, to the UE, the second transport block via a DG-PDSCH transmission.

The transmission component 1504 may transmit the second transport block via a second SPS occasion.

The transmission component 1504 may transmit the second transport block to the UE, wherein the second transport block is associated with a CS-RNTI, and wherein the first signaling comprises control information scheduling the second transport block having a C-RNTI that indicates that the first transport block has the same HARQ identifier as the second transport block.

The transmission component 1504 may transmit, to the UE, control signaling indicating that HARQ identifiers may be shared between transport blocks associated with CS-RNTIs and transport blocks associated with C-RNTIs, wherein receiving the second signaling is in response to transmitting the control signaling.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication by a UE, comprising: receiving, from a network node, first signaling associated with a first transport block, the first signaling indicating that the first transport block has a same HARQ identifier as a second transport block, wherein at least one of the first transport block and the second transport block are associated with SPS; identifying an unsuccessful termination of a HARQ process associated with the second transport block in response to a failure of the UE to successfully decode the second transport block, the first transport block having the same HARQ identifier as the second transport block, or an NDI associated with the same HARQ identifier; and transmitting, to the network node, second signaling indicating the unsuccessful termination of the HARQ process associated with the second transport block.

Aspect 2: The method of Aspect 1, further comprising: transmitting, to the network node prior to receiving the first signaling, a HARQ NACK associated with the second transport block; and identifying that the first transport block has the same HARQ identifier after transmitting the HARQ NACK and receiving the first signaling, wherein identifying the unsuccessful termination of the HARQ process is in response to the failure of the UE to successfully decode the second transport block and the first transport block having the same HARQ identifier as the second transport block.

Aspect 3: The method of any of Aspects 1-2, wherein: the second transport block is associated with a CS-RNTI; the second signaling comprises the same HARQ identifier; and the second signaling indicates that the unsuccessful termination of the HARQ process is associated with the second transport block by including an indication that the unsuccessful termination of the HARQ process is associated with the CS-RNTI.

Aspect 4: The method of any of Aspects 1-3, wherein: the second transport block is associated with a CS-RNTI; and the second signaling comprises an NDI field associated with the NDI associated with the same HARQ identifier, wherein the NDI field is set to: a first value indicating that the unsuccessful termination of the HARQ process is associated with a transport block received via an SPS occasion, or a second value indicating that the unsuccessful termination of the HARQ process is associated with a transport block that comprises a retransmission of an SPS transmission.

Aspect 5: The method of any of Aspects 1-4, further comprising: incrementing a value of the NDI in response to receiving, via an SPS occasion, any transport block associated with the same HARQ identifier, wherein the second signaling comprises an NDI field set to the value.

Aspect 6: The method of any of Aspects 1-5, further comprising: receiving, from the network node and after receiving the first signaling, control signaling comprising scheduling information for a third transport block, an indication that the third transport block is associated with the same HARQ identifier as the first transport block and the second transport block, and the NDI associated with the same HARQ identifier having a first value; and transmitting, to the network node, third signaling indicating that an expected value of the NDI is different from the first value of the NDI.

Aspect 7: The method of Aspect 6, further comprising: incrementing the expected value of the NDI in response to: receiving, via SPS occasions, transport blocks that are associated with the same HARQ identifier and that are associated with CS-RNTIs, and receiving, via DG-PDSCH transmissions, transport blocks that are associated with the same HARQ identifier and that are associated with C-RNTIs, wherein transmitting the third signaling is in response to incrementing the expected value of the NDI.

Aspect 8: The method of Aspect 6, further comprising: incrementing the expected value of the NDI in response to receiving, via DG-PDSCH transmissions, transport blocks that are associated with the same HARQ identifier and that are associated with C-RNTIs; and refraining from incrementing the expected value of the NDI in response to receiving transport blocks that are associated with the same HARQ identifier and that are associated with CS-RNTIs.

Aspect 9: The method of Aspect 6, further comprising: identifying the expected value of the NDI in response to the third transport block being an initial transport block associated with the same HARQ identifier received after a reception of another transport block associated with the same HARQ identifier and associated with a CS-RNTI.

Aspect 10: The method of any of Aspects 1-9, wherein receiving the first signaling associated with the first transport block comprises receiving the first transport block via an SPS occasion.

Aspect 11: The method of Aspect 10, further comprising: receiving, from the network node, the second transport block via a DG-PDSCH transmission.

Aspect 12: The method of Aspect 10, further comprising: receiving the second transport block via a second SPS occasion.

Aspect 13: The method of any of Aspects 1-12, further comprising: receiving, from the network node, the second transport block, wherein the second transport block is associated with a CS-RNTI, and wherein the first signaling comprises control information scheduling the second transport block having a C-RNTI that indicates that the first transport block has the same HARQ identifier as the second transport block.

Aspect 14: The method of Aspect 13, wherein receiving the second transport block comprises receiving the second transport block via an SPS occasion.

Aspect 15: The method of Aspect 13, wherein receiving the second transport block comprises receiving a retransmission of an SPS transmission of the second transport block.

Aspect 16: The method of any of Aspects 1-15, further comprising: receiving, from the network node, control signaling indicating that HARQ identifiers may be shared between transport blocks associated with CS-RNTIs and transport blocks associated with C-RNTIs, wherein transmitting the second signaling is in response to receiving the control signaling.

Aspect 17: A method of wireless communication by a network node, comprising: transmitting, to a UE, first signaling associated with a first transport block, the first signaling indicating that the first transport block has a same HARQ identifier as a second transport block, wherein at least one of the first transport block and the second transport block are associated with SPS; and receiving, from the UE, second signaling indicating an unsuccessful termination of a HARQ process associated with the second transport block in response to a failure of the UE to successfully decode the second transport block, the first transport block having the same HARQ identifier as the second transport block, or an NDI associated with the same HARQ identifier.

Aspect 18: The method of Aspect 17, further comprising: receiving, from the UE prior to receiving the first signaling, a HARQ NACK associated with the second transport block, wherein receiving the second signaling is in response to the failure of the UE to successfully decode the second transport block and the first transport block having the same HARQ identifier as the second transport block.

Aspect 19: The method of any of Aspects 17-18, wherein: the second transport block is associated with a CS-RNTI; the second signaling comprises the same HARQ identifier; and the second signaling indicates that the unsuccessful termination of the HARQ process is associated with the second transport block by including an indication that the unsuccessful termination of the HARQ process is associated with the CS-RNTI.

Aspect 20: The method of any of Aspects 17-19, wherein: the second transport block is associated with a CS-RNTI; and the second signaling comprises an NDI field associated with the NDI associated with the same HARQ identifier, wherein the NDI field is set to: a first value indicating that the unsuccessful termination of the HARQ process is associated with a transport block received via an SPS occasion, or a second value indicating that the unsuccessful termination of the HARQ process is associated with a transport block that comprises a retransmission of an SPS transmission.

Aspect 21: The method of any of Aspects 17-20, further comprising: transmitting, to the UE and after transmitting the first signaling, control signaling comprising scheduling information for a third transport block, an indication that the third transport block is associated with the same HARQ identifier as the first transport block and the second transport block, and the NDI associated with the same HARQ identifier having a first value; and receiving, from the UE, third signaling indicating that an expected value of the NDI is different from the first value of the NDI.

Aspect 22: The method of Aspect 21, wherein the expected value of the NDI is based at least in part on: a first quantity of transport blocks that are associated with the same HARQ identifier, that are associated with CS-RNTIs, and that are transmitted by the network node via SPS occasions; or a second quantity of transport blocks that are associated with the same HARQ identifier, that are associated with C-RNTIs, and that are transmitted by the network node via DG-PDSCH transmissions.

Aspect 23: The method of Aspect 21, wherein the expected value of the NDI is based at least in part on the third transport block being an initial transport block associated with the same HARQ identifier transmitted after a reception of another transport block associated with the same HARQ identifier and associated with a CS-RNTI.

Aspect 24: The method of any of Aspects 17-23, wherein transmitting the first signaling associated with the first transport block comprises transmitting the first transport block via an SPS occasion.

Aspect 25: The method of Aspect 24, further comprising: transmitting, to the UE, the second transport block via a DG-PDSCH transmission.

Aspect 26: The method of Aspect 24, further comprising: transmitting the second transport block via a second SPS occasion.

Aspect 27: The method of any of Aspects 17-26, further comprising: transmitting the second transport block to the UE, wherein the second transport block is associated with a CS-RNTI, and wherein the first signaling comprises control information scheduling the second transport block having a C-RNTI that indicates that the first transport block has the same HARQ identifier as the second transport block.

Aspect 28: The method of Aspect 27, wherein transmitting the second transport block comprises transmitting the second transport block via an SPS occasion.

Aspect 29: The method of Aspect 27, wherein transmitting the second transport block comprises transmitting a retransmission of an SPS transmission of the second transport block.

Aspect 30: The method of any of Aspects 17-29, further comprising: transmitting, to the UE, control signaling indicating that HARQ identifiers may be shared between transport blocks associated with CS-RNTIs and transport blocks associated with C-RNTIs, wherein receiving the second signaling is in response to transmitting the control signaling.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.

Aspect 32: An apparatus for wireless communication at a device, the apparatus comprising one or more memories and one or more processors coupled to the one or more memories, the one or more processors configured to cause the device to perform the method of one or more of Aspects 1-30.

Aspect 33: An apparatus for wireless communication, the apparatus comprising at least one means for performing the method of one or more of Aspects 1-30.

Aspect 34: A non-transitory computer-readable medium storing code for wireless communication, the code comprising instructions executable by one or more processors to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

Aspect 36: A device for wireless communication, the device comprising a processing system that includes one or more processors and one or more memories coupled with the one or more processors, the processing system configured to cause the device to perform the method of one or more of Aspects 1-30.

Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive, from a network node, first signaling associated with a first transport block, the first signaling indicating that the first transport block has a same hybrid automatic repeat request (HARQ) identifier as a second transport block, wherein at least one of the first transport block and the second transport block are associated with semi-persistent scheduling (SPS);
identify an unsuccessful termination of a HARQ process associated with the second transport block in response to a failure of the UE to successfully decode the second transport block, the first transport block having the same HARQ identifier as the second transport block, or a new data indicator associated with the same HARQ identifier; and
transmit, to the network node, second signaling indicating the unsuccessful termination of the HARQ process associated with the second transport block.

2. The UE of claim 1, wherein the processing system is further configured to cause the UE to:
transmit, to the network node prior to receiving the first signaling, a HARQ negative acknowledgement (NACK) associated with the second transport block; and
identify that the first transport block has the same HARQ identifier after transmitting the HARQ NACK and receiving the first signaling, wherein identifying the unsuccessful termination of the HARQ process is in response to the failure of the UE to successfully decode the second transport block and the first transport block having the same HARQ identifier as the second transport block.

3. The UE of claim 1, wherein:
the second transport block is associated with a configured scheduling radio network temporary identifier (CS-RNTI);
the second signaling comprises the same HARQ identifier; and
the second signaling indicates that the unsuccessful termination of the HARQ process is associated with the second transport block by including an indication that the unsuccessful termination of the HARQ process is associated with the CS-RNTI.

4. The UE of claim 1, wherein:
the second transport block is associated with a configured scheduling radio network temporary identifier (CS-RNTI); and
the second signaling comprises a new data indicator field associated with the new data indicator associated with the same HARQ identifier, wherein the new data indicator field is set to:
a first value indicating that the unsuccessful termination of the HARQ process is associated with a transport block received via an SPS occasion, or
a second value indicating that the unsuccessful termination of the HARQ process is associated with a transport block that comprises a retransmission of an SPS transmission.

5. The UE of claim 1, wherein the processing system is further configured to cause the UE to:
increment a value of the new data indicator in response to receiving, via an SPS occasion, any transport block associated with the same HARQ identifier, wherein the second signaling comprises a new data indicator field set to the value.

6. The UE of claim 1, wherein the processing system is further configured to cause the UE to:
receive, from the network node and after receiving the first signaling, control signaling comprising scheduling information for a third transport block, an indication that the third transport block is associated with the same HARQ identifier as the first transport block and the second transport block, and the new data indicator associated with the same HARQ identifier having a first value; and
transmit, to the network node, third signaling indicating that an expected value of the new data indicator is different from the first value of the new data indicator.

7. The UE of claim 6, wherein the processing system is further configured to cause the UE to:
increment the expected value of the new data indicator in response to:
receiving, via SPS occasions, transport blocks that are associated with the same HARQ identifier and that are associated with configured scheduling radio network temporary identifiers (CS-RNTIs), and
receiving, via dynamic grant physical downlink shared channel (DG-PDSCH) transmissions, transport blocks that are associated with the same HARQ identifier and that are associated with cell radio network temporary identifiers (C-RNTIs), wherein, to cause the UE to transmit the third signaling, the processing system is configured to cause the UE to transmit the third signaling in response to incrementing the expected value of the new data indicator.

8. The UE of claim 6, wherein the processing system is further configured to cause the UE to:
increment the expected value of the new data indicator in response to receiving, via dynamic grant physical downlink shared channel (DG-PDSCH) transmissions, transport blocks that are associated with the same HARQ identifier and that are associated with cell radio network temporary identifiers (C-RNTIs); and
refrain from incrementing the expected value of the new data indicator in response to receiving transport blocks that are associated with the same HARQ identifier and that are associated with configured scheduling radio network temporary identifiers (CS-RNTIs).

9. The UE of claim 6, wherein the processing system is further configured to cause the UE to:
identify the expected value of the new data indicator in response to the third transport block being an initial transport block associated with the same HARQ identifier received after a reception of another transport block associated with the same HARQ identifier and associated with a configured scheduling radio network temporary identifier (CS-RNTI).

10. The UE of claim 1, wherein, to cause the UE to receive the first signaling, the processing system is configured to cause the UE to receive the first transport block via an SPS occasion.

11. The UE of claim 10, wherein the processing system is further configured to cause the UE to:
receive, from the network node, the second transport block via a dynamic grant physical downlink shared channel (DG-PDSCH) transmission.

12. The UE of claim 10, wherein the processing system is further configured to cause the UE to:
receive the second transport block via a second SPS occasion.

13. The UE of claim 1, wherein the processing system is further configured to cause the UE to:
receive, from the network node, the second transport block, wherein the second transport block is associated with a configured scheduling radio network temporary identifier (CS-RNTI), and wherein the first signaling comprises control information scheduling the second transport block having a cell radio network temporary identifier (C-RNTI) that indicates that the first transport block has the same HARQ identifier as the second transport block.

14. The UE of claim 13, wherein, to cause the UE to receive the second transport block, the processing system is configured to cause the UE to receive the second transport block via an SPS occasion.

15. The UE of claim 13, wherein, to cause the UE to receive the second transport block, the processing system is configured to cause the UE to receive a retransmission of an SPS transmission of the second transport block.

16. The UE of claim 1, wherein the processing system is further configured to cause the UE to:
receive, from the network node, control signaling indicating that HARQ identifiers may be shared between transport blocks associated with CS-RNTIs and transport blocks associated with cell radio network temporary identifiers (C-RNTIs), wherein, to cause the UE to transmit the second signaling, the processing system is configured to cause the UE to transmit the second signaling is in response to receiving the control signaling.

17. An apparatus for wireless communication at a network node, comprising:
a processing system that includes one or more processors and one or more memories coupled with the one or more processors, the processing system configured to cause the network node to:
transmit, to a user equipment (UE), first signaling associated with a first transport block, the first signaling indicating that the first transport block has a same hybrid automatic repeat request (HARQ) identifier as a second transport block, wherein at least one of the first transport block and the second transport block are associated with semi-persistent scheduling (SPS); and
receive, from the UE, second signaling indicating an unsuccessful termination of a HARQ process associated with the second transport block in response to a failure of the UE to successfully decode the second transport block, the first transport block having the same HARQ identifier as the second transport block, or a new data indicator associated with the same HARQ identifier.

18. The network node of claim 17, wherein the processing system is further configured to cause the network node to:
receive, from the UE prior to receiving the first signaling, a HARQ negative acknowledgement (NACK) associated with the second transport block, wherein, to cause the network node to receive the second signaling, the processing system is configured to cause the network node to receive the second signaling in response to the failure of the UE to successfully decode the second transport block and the first transport block having the same HARQ identifier as the second transport block.

19. The network node of claim 17, wherein:
the second transport block is associated with a configured scheduling radio network temporary identifier (CS-RNTI);
the second signaling comprises the same HARQ identifier; and
the second signaling indicates that the unsuccessful termination of the HARQ process is associated with the second transport block by including an indication that the unsuccessful termination of the HARQ process is associated with the CS-RNTI.

20. The network node of claim 17, wherein:
the second transport block is associated with a configured scheduling radio network temporary identifier (CS-RNTI); and
the second signaling comprises a new data indicator field associated with the new data indicator associated with the same HARQ identifier, wherein the new data indicator field is set to:
a first value indicating that the unsuccessful termination of the HARQ process is associated with a transport block received via an SPS occasion, or
a second value indicating that the unsuccessful termination of the HARQ process is associated with a transport block that comprises a retransmission of an SPS transmission.

21. The network node of claim 17, wherein the processing system is further configured to cause the network node to:
transmit, to the UE and after transmitting the first signaling, control signaling comprising scheduling information for a third transport block, an indication that the third transport block is associated with the same HARQ identifier as the first transport block and the second transport block, and the new data indicator associated with the same HARQ identifier having a first value; and
receive, from the UE, third signaling indicating that an expected value of the new data indicator is different from the first value of the new data indicator.

22. The network node of claim 21, wherein the expected value of the new data indicator is based at least in part on:
a first quantity of transport blocks that are associated with the same HARQ identifier, that are associated with configured scheduling radio network temporary identifiers (CS-RNTIs), and that are transmitted by the network node via SPS occasions; or
a second quantity of transport blocks that are associated with the same HARQ identifier, that are associated with cell radio network temporary identifiers (C-RNTIs), and that are transmitted by the network node via dynamic grant physical downlink shared channel (DG-PDSCH) transmissions.

23. The network node of claim 21, wherein the expected value of the new data indicator is based at least in part on the third transport block being an initial transport block associated with the same HARQ identifier transmitted after a reception of another transport block associated with the same HARQ identifier and associated with a configured scheduling radio network temporary identifier (CS-RNTI).

24. The network node of claim 17, wherein, to cause the network node to transmit the first signaling, the processing system is configured to cause the network node to transmit the first transport block via an SPS occasion.

25. The network node of claim 24, wherein the processing system is further configured to cause the network node to:
transmit, to the UE, the second transport block via a dynamic grant physical downlink shared channel (DG-PDSCH) transmission.

26. The network node of claim 24, wherein the processing system is further configured to cause the network node to:
transmit the second transport block via a second SPS occasion.

27. The network node of claim 17, wherein the processing system is further configured to cause the network node to:
transmit the second transport block to the UE, wherein the second transport block is associated with a configured scheduling radio network temporary identifier (CS-RNTI), and wherein the first signaling comprises control information scheduling the second transport block having a cell radio network temporary identifier (C-RNTI) that indicates that the first transport block has the same HARQ identifier as the second transport block.

28. The network node of claim 17, wherein the processing system is further configured to cause the network node to:
transmit, to the UE, control signaling indicating that HARQ identifiers may be shared between transport blocks associated with CS-RNTIs and transport blocks associated with cell radio network temporary identifiers (C-RNTIs), wherein receiving the second signaling is in response to transmitting the control signaling.

29. A method of wireless communication by a user equipment (UE), comprising:
receiving, from a network node, first signaling associated with a first transport block, the first signaling indicating that the first transport block has a same hybrid automatic repeat request (HARQ) identifier as a second transport block, wherein at least one of the first transport block and the second transport block are associated with semi-persistent scheduling (SPS);
identifying an unsuccessful termination of a HARQ process associated with the second transport block in response to a failure of the UE to successfully decode the second transport block, the first transport block having the same HARQ identifier as the second transport block, or a new data indicator associated with the same HARQ identifier; and
transmitting, to the network node, second signaling indicating the unsuccessful termination of the HARQ process associated with the second transport block.

30. A method of wireless communication by a network node, comprising:
transmitting, to a user equipment (UE), first signaling associated with a first transport block, the first signaling indicating that the first transport block has a same hybrid automatic repeat request (HARQ) identifier as a second transport block, wherein at least one of the first transport block and the second transport block are associated with semi-persistent scheduling (SPS); and
receiving, from the UE, second signaling indicating an unsuccessful termination of a HARQ process associated with the second transport block in response to a failure of the UE to successfully decode the second transport block, the first transport block having the same HARQ identifier as the second transport block, or a new data indicator associated with the same HARQ identifier.
